(19) United States
(12) Patent Application Publication
(10) Pub. No.: US 2025/0233986 A1
(43) Pub. Date: Jul. 17, 2025

(54) ENCODING METHOD, DECODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Hongqing DU, Dongguan (CN); Fuzheng YANG, Dongguan (CN); Ming LI, Dongguan (CN)

(21) Appl. No.: 19/171,542

(22) Filed: Apr. 7, 2025

Related U.S. Application Data
(63) Continuation of application No. PCT/CN2022/124872, filed on Oct. 12, 2022.

(51) Int. Cl. H04N 19/105; H04N 19/117; H04N 19/132; H04N 19/159; H04N 19/176; H04N 19/186; H04N 19/463; H04N 19/50; H04N 19/82

(52) U.S. Cl. CPC H04N 19/105; H04N 19/117; H04N 19/132; H04N 19/159; H04N 19/176; H04N 19/186; H04N 19/463; H04N 19/50; H04N 19/82

(57) ABSTRACT

An encoding method includes: decoding a bitstream to determine prediction parameters of a current block; determining a first prediction block of the current block according to the prediction parameters; determining model parameters according to a first color component value and a second color component value of the first prediction block; determining a reference sample value of a first color component sample of the current block; determining a prediction value of a second color component sample of the current block according to the reference sample value of the first color component sample of the current block and the model parameters; and determining a reconstructed value of the second color component sample of the current block according to the prediction value of the second color component sample of the current block.

### CROSS-REFERENCE TO RELATED APPLICATION

This application is a Continuation Application of PCT/CN2022/124872 filed Oct. 12, 2022, which is incorporated herein by reference in its entirety.

### TECHNICAL FIELD

Embodiments of the present application relate to the field of video coding technology, and in particular, to an encoding method, a decoding method, a bitstream, an encoder, a decoder, and a storage medium.

### BACKGROUND

In an inter prediction process, motion compensation may be divided into unidirectional motion compensation and bidirectional motion compensation according to slice types. For a current block, a matching block of the current block is determined from a reference picture List0 and/or a reference picture List1 according to motion vector information, and then weighted prediction is performed according to the determined matching block, to obtain an inter prediction block of the current block.

Generally, for the matching block determined by the reference picture List0 and/or the reference picture List1, a fixed weighting factor is used to perform weighted prediction to determine the inter prediction block of the current block. However, the weighting factor of the weighted prediction method cannot be adapt to local characteristics of different sample of the current block, which leads to inaccurate prediction of the current block and reduces coding efficiency.

### SUMMARY

Technical solutions of the embodiments of the present application may be implemented as follows.

In a first aspect, the embodiments of the present application provide a decoding method, which includes:
decoding a bitstream to determine prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a reconstructed value of the second color component sample of the current block according to the prediction value of the second color component sample of the current block.

In a second aspect, the embodiments of the present application provide an encoding method, which includes:
determining prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a prediction residual value of the second color component sample of the current block according to the prediction value of the second color component sample of the current block.

In a third aspect, the embodiments of the present application provide a bitstream, which is generated by bit encoding according to information to be encoded; where the information to be encoded includes at least one of:
a prediction residual value of a second color component sample of a current block, prediction parameters of the current block, the number of coefficients of a target filter, a shape of the target filter, a value of a filter shape parameter, first flag information of a block category of the current block, or second flag information of the block category of the current block.

In a fourth aspect, the embodiments of the present application provide an encoder, and the encoder includes: a first determining unit and a first predicting unit; where
the first determining unit is configured to determine prediction parameters of a current block; and determine a first prediction block of the current block according to the prediction parameters;
the first determining unit is further configured to determine model parameters according to a first color component value and a second color component value of the first prediction block;
the first prediction unit is configured to determine a reference sample value of a first color component sample of the current block, and determine a prediction value of a second color component sample of the current block according to the reference sample value of the first color component sample of the current block and the model parameters;
the first determining unit is further configured to determine a prediction residual value of the second color component sample of the current block according to the prediction value of the second color component sample of the current block.

In a fifth aspect, the embodiments of the present application provide an encoder, and the encoder includes: a first memory and a first processor; where
the first memory is configured to store a computer program that is able to be run on the first processor; and the first processor is configured to perform the method described in the second aspect when running the computer program.

In a sixth aspect, the embodiments of the present application provide a decoder, and the decoder includes: a decoding unit, a second determining unit, and a second predicting unit; where
the decoding unit is configured to decode a bitstream to determine prediction parameters of a current block;
the second determining unit is configured to determine a first prediction block of the current block according to the prediction parameters; and determine model parameters according to a first color component value and a second color component value of the first prediction block;
the second prediction unit is configured to determine a reference sample value of a first color component sample of the current block, and determine a prediction value of a second color component sample of the current block according to the reference sample value of the first color component sample of the current block and the model parameters;
the second determining unit is further configured to determine a reconstructed value of the second color component sample of the current block according to the prediction value of the second color component sample of the current block.

In a seventh aspect, the embodiments of the present application provide a decoder, and the decoder includes: a second memory and a second processor; where
the second memory is configured to store a computer program that is able to be run on the second processor; and
the second processor is configured to perform the method described in the first aspect when running the computer program.

In an eighth aspect, the embodiments of the present application provide a non-transitory computer-readable storage medium, the non-transitory computer-readable storage medium stores a computer program, and when the computer program is executed, the method as described in the first aspect is implemented, or the method as described in the second aspect is implemented.

### BRIEF DESCRIPTION OF THE DRAWINGS

FIG. 1 is a schematic flowchart of unidirectional prediction (uni-prediction).

FIG. 2 is a schematic flowchart of bidirectional prediction (bi-prediction).

FIG. 3 is a schematic flowchart of weighted prediction.

FIG. 4 is a schematic flowchart of another weighted prediction.

FIG. 5A is a schematic composition block diagram of an encoder provided by embodiments of the present application.

FIG. 5B is a schematic composition block diagram of a decoder provided by embodiments of the present application.

FIG. 6 is a schematic diagram of network architecture of a coding system provided by embodiments of the present application.

FIG. 7 is a schematic flowchart of a decoding method provided by embodiments of the present application.

FIG. 8 is a schematic flow block diagram of a decoding method provided by embodiments of the present application.

FIG. 9 is a schematic flowchart of an encoding method provided by embodiments of the present application.

FIG. 10 is a schematic flowchart of CP-CCCM prediction provided by embodiments of the present application.

FIG. 11 is a schematic diagram of another type of CP-CCCM prediction provided by embodiments of the present application.

FIG. 12 is a schematic composition diagram of a filter provided by embodiments of the present application.

FIG. 13A is a schematic composition diagram of filter coefficients provided by embodiments of the present application.

FIG. 13B is a schematic composition diagram of chroma prediction samples provided by embodiments of the present application.

FIG. 14 is a schematic flowchart of a CP-CCCM uni-prediction process provided by embodiments of the present application.

FIG. 15 is a schematic flowchart of a CP-CCCM bi-prediction process provided by embodiments of the present application.

FIG. 16 is a schematic diagram of a composition structure of an encoder provided by embodiments of the present application.

FIG. 17 is a schematic diagram of a hardware structure of an encoder provided by embodiments of the present application.

FIG. 18 is a schematic diagram of a composition structure of a decoder provided by embodiments of the present application.

FIG. 19 is a schematic diagram of a hardware structure of a decoder provided by embodiments of the present application.

FIG. 20 is a schematic diagram of a composition structure of a coding system provided by embodiments of the present application.

### DETAILED DESCRIPTION

In order to be able to understand the characteristics and technical contents of the embodiments of the present application in more detail, implementations of the embodiments of the present application will be described in detail below in conjunction with the accompanying drawings. The accompanying drawings are for illustrative purposes only and are not intended to limit the embodiments of the present application.

Unless defined otherwise, all technical and scientific terms used herein have the same meaning as commonly understood by those skilled in the art belonging to this application. The terms used herein are only for a purpose of describing the embodiments of the present application and are not intended to limit the present application.

In the following description, reference is made to “some embodiments”, which describe a subset of all possible embodiments, but it will be understood that “some embodiments” may be the same subset or different subsets of all possible embodiments and may be combined with each other without conflict. It should also be pointed out that the terms “first \second\third” involved in the embodiments of the present application are only used for distinguishing similar objects and do not indicate a specific order of the objects. It may be understood that “first\second\third” may be interchanged in a specific order or sequence where permitted, so that the embodiments of the present application described here may be implemented in an order other than that illustrated or described herein.

In a video picture, a first color component, a second color component, and a third color component are generally used to specify a coding block (CB); where the three color components are a luma component, a blue chroma component, and a red chroma component, respectively. Specifically, the luma component is usually represented by a symbol Y, the blue chroma component is usually represented by a symbol Cb or U, and the red chroma component is usually represented by a symbol Cr or V; thus, the video picture may be represented in a YCbCr format or in a YUV format.

It may be understood that in a current video picture or video coding process, the cross-component prediction technology mainly includes a cross-component linear model (CCLM) prediction mode and a multi-directional linear model (MDLM) prediction mode. Regardless of model factors derived according to the CCLM prediction mode or the model factors derived according to the MDLM prediction mode, the corresponding prediction model may realize prediction between color components, such as the prediction from the first color component to the second color component, the prediction from the second color component to the first color component, the prediction from the first color component to the third color component, the prediction from the third color component to the first color component, the prediction from the second color component to the third color component, or the prediction from the third color component to the second color component.

Taking the prediction from the first color component to the second color component as an example, assuming that the first color component is a luma component and the second color component is a chroma component, in order to reduce the redundancy between the luma component and the chroma component, the CCLM prediction mode is used in VVC, that is, a chroma prediction value is constructed according to a luma reconstructed value of the same coding block, such as: Pred_{C}(i, j)=α·Rec_{L}(i,j)+β.

Here, i, j indicates a position coordinate of a sample to be predicted in the coding block, i represents a horizontal direction, and j represents a vertical direction; Pred_{C}(i, j) represents a chroma prediction value corresponding to the sample to be predicted at the position coordinate (i, j) in the coding block, and Rec_{L}(i, j) represents a luma reconstructed value corresponding to the sample to be predicted at the position coordinate (i, j) (after down-sampling) in the same coding block. In addition, a and B represent model factors, which are obtained by deriving from the reference sample.

In an inter prediction process, motion compensation may be divided into unidirectional motion compensation and bidirectional motion compensation according to slice types. Then the current block determines a matching block of the current block from a List0 reference picture or a List1 reference picture according to motion vector (MV) information, and determines a prediction block of the current block according to the matching block. The matching block here may also be called a “compensation block”.

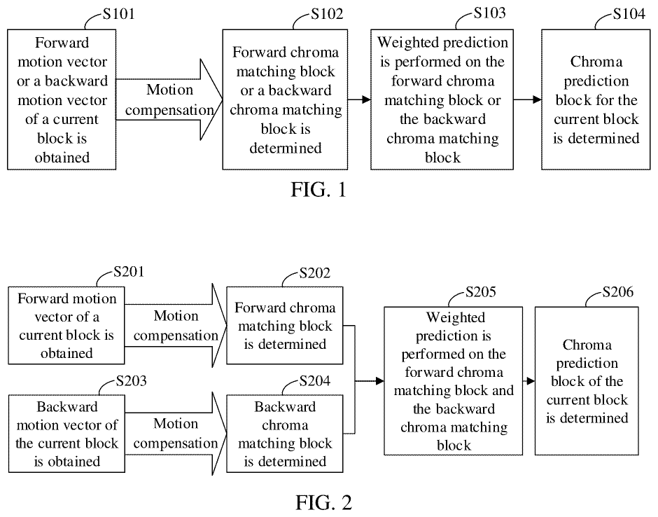

In a case of performing the uni-prediction (i.e., List0 prediction or List1 prediction), the matching block is determined from a List0 reference picture or a List1 reference picture, and the matching block is weighted to obtain an inter prediction block of the current block. The processes of chroma weighted prediction and luma weighted prediction are similar. Taking chroma weighted prediction as an example, as shown in FIG. 1, the process may include following contents.

S101, a forward motion vector or a backward motion vector of a current block is obtained.

S102, a forward chroma matching block or a backward chroma matching block is determined.

S103, weighted prediction is performed on the forward chroma matching block or the backward chroma matching block.

S104, a chroma prediction block of the current block is determined.

In a case of performing bi-prediction, a List0 matching block is determined from a List0 reference picture, and a List1 matching block is determined from a List1 reference picture, and then weighted prediction is performed on the List0 matching block and the List1 matching block to obtain an inter prediction block of the current block. The processes of chroma weighted prediction and luma weighted prediction are similar, and chroma weighted prediction is still taken as an example, as shown in FIG. 2, the process may include following contents.

S201, a forward motion vector of a current block is obtained.

S202, a forward chroma matching block is determined.

S203, a backward motion vector of the current block is obtained.

S204, a backward chroma matching block is determined.

S205, weighted prediction is performed on the forward chroma matching block and the backward chroma matching block.

S206, a chroma prediction block of the current block is determined.

It should be noted that the current block may be a current coding unit (CU), a current transform unit (TU), a current prediction unit (PU), a current coding block (CB), etc., which is not be specifically limited in the embodiments of the present application.

It should also be noted that, in H.266/VVC, the weighted prediction (WP) algorithm mainly includes: a default weighted prediction (Defaul WP) algorithm, an explicit weighted prediction (Explicit WP) algorithm and a bidirectional weighted prediction with CU-level Weights (Bi-prediction with CU-level Weights, BCW) algorithm. The following will introduce the relevant technologies for the weighted prediction algorithms respectively.

The data processing process of inter weighted prediction is as follows.

Weighted prediction input: coordinate information (xCb, yCb) of the current block, a width nCbW and a height nCbH, prediction blocks predSamplesL0 and predSamplesL1, prediction list usage flags predFlagL0 and predFlagL1, reference picture indexes refIdxL0 and refIdxL1, a BCW weight index bcwIdx, and a color component index cIdx.

Weighted prediction output: prediction block pbSamples of (nCbW)(nCbH).

For the weighted prediction process, in order to effectively improve the prediction coding effect of a gradual video sequence, the inter weighted prediction method is used in VVC, to obtain a final inter prediction value of the current picture via a weight and an offset value for the prediction blocks predSamplesL0 and predSamplesL1 after the unidirectional or bidirectional motion compensation of the current picture, thereby achieving a purpose of correcting the motion compensated prediction samples in a P picture or a B picture. Here, in VVC, two weighted prediction algorithms are specified: the default weighted prediction and the explicit weighted prediction. In addition, for the current block with bi-prediction, in VVC, BCW may also be used to determine a weight factor of its weighted prediction. Exemplarily, five candidate weight factors are preset in BCW, and the weight factor of BCW is determined according to a value of an index number of the weight factor.

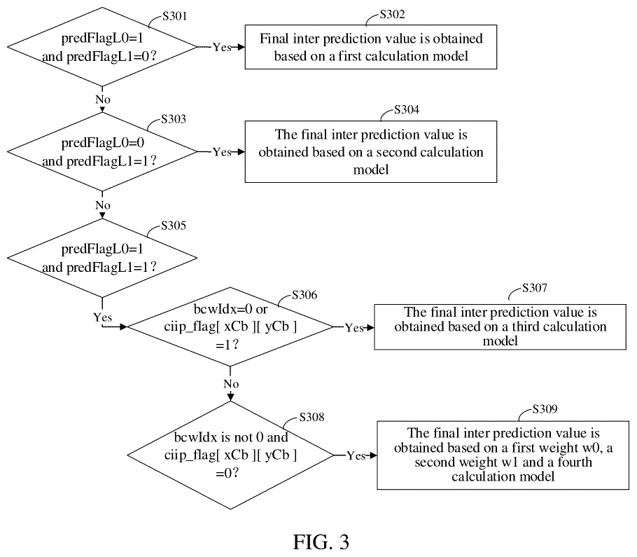

(1) Considering that the default weighted prediction process and the BCW prediction process have the same data processing steps, the same weighted prediction flow may be used in the default weighted prediction process and the BCW prediction process, as shown in FIG. 3, the flow may include following contents.

S301, whether predFlagL0 is equal to 1 (i.e., predFlagL0=1) and predFlagL1 is equal to 0 (i.e., predFlagL1=0) is determined.

S302, a final inter prediction value is obtained based on a first calculation model.

S303, whether predFlagL0 is equal to 0 (i.e., predFlagL0=0) and predFlagL1 is equal to 1 (i.e., predFlagL1=1) is determined.

S304, the final inter prediction value is obtained based on a second calculation model.

S305, whether predFlagL0 is equal to 1 (i.e., predFlagL0=1) and predFlagL1 is equal to 1 (i.e., predFlagL1=1) is determined.

It should be noted that, for S301, in response to that the result is yes, S302 is executed, that is, the final inter prediction value is obtained based on the first calculation model; or in response to that the result is no, S303 is executed, that is, it is further determined whether predFlagL0=0 and predFlagL1=1 holds true. For S303, in response to that the result is yes, S304 is executed, that is, the final inter prediction value is obtained based on the second calculation model; or in response to that the result is no, S305 is executed, that is, it is further determined whether predFlagL0=1 and predFlagL1=1 holds true.

S306, whether bcwIdx is equal to 0 (i.e., bcwIdx=0) or ciip_flag [xCb][yCb] is equal to 1 (i.e., ciip_flag [xCb][yCb]=1) is determined.

S307, the final inter prediction value is obtained based on a third calculation model.

S308, whether bcwIdx is not 0 and ciip_flag [xCb][yCb] is equal to 0 (i.e., ciip_flag [xCb][yCb]=0) is determined.

S309, the final inter prediction value is obtained based on a first weight w0, a second weight w1 and a fourth calculation model.

It should also be noted that, for S305, in response to that the result is yes, S306 is executed, that is, it is further determined whether bcwIdx=0 or ciip_flag [xCb][yCb]=1 holds true. For S306, in response to that the result is yes, S307 is executed, that is, the final inter prediction value is obtained based on the third calculation model; or in response to that the result is no, S308 is executed, that is, it is further determined whether bcwIdx is not 0 and ciip_flag [xCb][yCb]=0 holds true. In this case, in response to that the further result is yes, then S309 may be executed, that is, the final inter prediction value is obtained based on the first weight w0, the second weight w1 and the fourth calculation model.

In the embodiments of the present application, the default weighted prediction process may be divided into three cases for processing according to usage conditions of a reference list.

Case 1: using only a reference list List0, a predicted sample pbSamples[x][y] may be calculated using the first calculation model, and the first calculation model is as follows:

$$pbSamples [ x ] [ y ] = Clip 3 ( 0 , ( 1 ≪ bitDepth ) - 1 , ( predSamplesL 0 [ x ] [ y ] + offset 1 ) ≫ shift 1 ) \qquad ( 1 )$$

Case 2: using only a reference list List1, the predicted sample pbSamples[x][y] may be calculated using the second calculation model, and the second calculation model is as follows:

$$pbSamples [ x ] [ y ] = Clip 3 ( 0 , ( 1 ≪ bitDepth ) - 1 , ( predSamplesL 1 [ x ] [ y ] + offset 1 ) ≫ shift 1 ) \qquad ( 2 )$$

Case 3: using both reference lists List0 and List1, the predicted sample pbSamples [x][y] may be calculated using the third calculation model, and the third calculation model is as follows:

$$pbSamples [ x ] [ y ] = Clip 3 ( 0 , ( 1 ≪ bitDepth ) - 1 , \\ ( predSamplesL 0 [ x ] [ y ] + predSamplesL 1 [ x ] [ y ] + offset 2 ) ≫ shift 2 ) \qquad ( 3 )$$

Here, predSamplesL0[x][y] and predSamplesL1[x][y] represent the List0 prediction value and List1 prediction value of the current block respectively, and x and y represent the horizontal and vertical coordinates of the samples of the current block respectively. In addition, shift1, shift2, offset1, and offset2 do not need to be transmitted in the bitstream, but only need to be determined according to the bitDepth of a input sequence, which are as follows:

$$shift 1 = Max ( 2 , 14 - bitDepth ) \qquad ( 4 )$$

$$shift 2 = Max ( 3 , 15 - bitDepth ) \qquad ( 5 )$$

$$offset 1 = 1 ≪ ( shift 1 - 1 ) \qquad ( 6 )$$

$$offset 2 = 1 ≪ ( shift 2 - 1 ) \qquad ( 7 )$$

In the embodiments of the present application, for the BCW prediction process, the BCW may be used to determine the weight factor of its weighted prediction. 5 candidate weight factors are preset in BCW, and the weight factor of BCW is determined according to the value of the index number of the weight factor. The data processing process is as follows.

In response to that bcwIdx (i.e., the index number of the BCW weight factor) is 0 or ciip_flag is 1, the predicted sample pbSamples[x][y] may be calculated using the third calculation model, and the third calculation model is shown in the formula (3).

In response to that bcwIdx is not 0 and ciip_flag is 0, the second weight (i.e., the backward prediction block weight) w1 is determined to be bcwWLut[bcwIdx], where bcwWLut[k]={4,5,3,10,−2}; accordingly, the first weight (i.e., the forward prediction block weight) w0 is 8−w1, and the predicted sample pbSamples[x][y] may be calculated using a fourth calculation model, and the fourth calculation model is as follows:

$$pbSamples [ x ] [ y ] = Clip 3 ( 0 , ( 1 ≪ bitDepth ) - 1 , ( w 0 * predSamplesL 0 [ x ] [ y ] + w 1 * predSamplesL 1 [ x ] [ y ] + offset 3 ) ≫ ( shift 1 + 3 ) ) \qquad ( 8 )$$

Here, a value of offset3 is set to 1<< (shift1+2).

(2) For the explicit weighted prediction process, cfg is disabled by default. As shown in FIG. 4, the process may include following contents.

S401, some variables w0, w1, o0, o1 are obtained via conditions.

In the embodiments of the present application, it is first determined whether the current block is a luma component. In response to that the current block is the luma component, log 2Wd is equal to a sum of LumaLog2WeightDenom and shift1 (i.e., log 2Wd=LumaLog2WeightDenom+shift1); where
in a case that predFlagL0 is equal to 1 (i.e., predFlagL0=1), w0 is equal to LumaWeightL0[refIdxL0] (i.e., w0=LumaWeightL0[refIdxL0]), and o0 is equal to LumaOffsetL0[refIdxL0]<<(bitDepth−8) (i.e., 00=LumaOffsetL0[refIdxL0]<<(bitDepth−8)); and
in a case that predFlagL1 is equal to 1 (i.e., predFlagL1=1), w1 is equal to LumaWeightL1[refIdxL1] (i.e., w1=LumaWeightL1[refIdxL1]), and o1 is equal to LumaOffsetL1[refIdxL1]<<(bitDepth−8) (i.e., o1=LumaOffsetL1[refIdxL1]<<(bitDepth−8)).

In response to that the current block is a chroma component, log 2Wd is equal to a sum of ChromaLog2WeightDenom and shift1 (i.e., log 2Wd=ChromaLog2WeightDenom+shift1); where
in a case that predFlagL0 is equal to 1 (i.e., predFlagL0=1), w0 is equal to ChromaWeightL0[refIdxL0][cIdx−1] (i.e., w0=ChromaWeightL0[refIdxL0][cIdx−1]), o0 is equal to Chroma OffsetL0[refIdxL0][CIdx−1]< (bitDepth−8) (i.e., o0=Chroma OffsetL0[refIdxL0][cIdx−1]<<(bitDepth−8)); and in a case that predFlagL1 is equal to 1 (i.e., predFlagL1=1), w1 is equal to ChromaWeightL1[refIdxL1][cIdx−1] (i.e., w1=ChromaWeightL1[refIdxL1][cIdx−1]), o1 is equal to Chroma OffsetL1[refIdxL1][CIdx−1]<<(bitDepth−8) (i.e., o1=Chroma OffsetL1[refIdxL1][cIdx−1]<<(bitDepth−8)).

S402, the final inter prediction value is obtained by performing the weighted calculation on the variables w0, w1, o0, o1.

In the embodiments of the present application, the step of determining the final inter prediction value may include following steps.

S403, whether predFlagL0 is equal to 1 (i.e., predFlagL0=1) and predFlagL1 is equal to 0 (i.e., predFlagL1=0) is determined.

S404, the final inter prediction value is obtained based on a fifth calculation model.

S405, whether predFlagL0 is equal to 0 (i.e., predFlagL0=0) and predFlagL1 is equal to 1 (i.e., predFlagL1=1) is determined.

S406, the final inter prediction value is obtained based on a sixth calculation model.

S407, whether predFlagL0 is equal to 1 (i.e., predFlagL0=1) and predFlagL1 is equal to 1 (i.e., predFlagL1=1) is determined.

S408, the final inter prediction value is obtained based on a seventh calculation model.

It should be noted that, for S403, in response to that the result is yes, S404 is executed, that is, the final inter prediction value is obtained based on the fifth calculation model; or in response to that the result is no, S405 is executed to further determine whether predFlagL0=0 and predFlagL1=1 holds true. For S405, in response to that the result is yes, S406 is executed, that is, the final inter prediction value is obtained based on the sixth calculation model; or in response to that the result is no, S407 is executed to further determine whether predFlagL0=1 and predFlagL1=1 holds true, In this case, in response to that the further result is yes, S408 may be executed, that is, the final inter prediction value is obtained based on the seventh calculation model.

It should also be noted that, for the explicit weighted prediction, a certain weight and offset are needed to perform weighted correction on predSamplesL0[x][y] and predSamplesL1[x][y] during the motion compensation process. Similarly, the explicit weighted prediction may also be divided into three cases according to the usage conditions of the reference list:

Case 1: using only the reference list List0, the predicted sample pbSamples[x][y] may be calculated using the fifth calculation model, and the fifth calculation model is as follows:

$$pbSamples [ x ] [ y ] = Clip 3 ( 0 , ( 1 ≪ bitDepth ) - 1 , \\ ( ( predSamplesL 0 [ x ] [ y ] * w 0 + {2}^{log 2 Wd - 1} ) ≫ log 2 Wd ) + o 0 ) \qquad ( 9 )$$

Case 2: using only the reference list List1, the predicted sample pbSamples[x][y] may be calculated using the sixth calculation model, and the sixth calculation model is as follows:

$$pbSamples [ x ] [ y ] = Clip 3 ( 0 , ( 1 ≪ bitDepth ) - 1 , \\ ( ( predSamplesL 1 [ x ] [ y ] * w 1 + {2}^{log 2 Wd - 1} ) ≫ log 2 Wd ) + o 1 ) \qquad ( 10 )$$

Case 3: using both reference lists List0 and List1, the predicted sample pbSamples[x][y] may be calculated using the seventh calculation model, and the seventh calculation model is as follows:

$$pbSamples [ x ] [ y ] = Clip 3 ( 0 , ( 1 ≪ bitDepth ) - 1 , ( predSamplesL 0 [ x ] [ y ] * w 0 + predSamplesL 1 [ x ] [ y ] * w 1 + ( ( o 0 + o 1 + 1 ) ≪ log 2 Wd ) ) ≫ ( log 2 Wd + 1 ) ) \qquad ( 11 )$$

Here, w0 and w1 represent weights, o0 and o1 represent corresponding offsets. At the decoding end, values of the four variables may be directly determined by decoding the bitstream.

Generally, the current chroma weighted prediction method uses a fixed weight factor to perform weighted fusion on the prediction values of the List0 prediction block and the List1 prediction block, to determine a chroma inter prediction value of the current block. Therefore, the weight factor of this method cannot adapt to local characteristics on different samples of the chroma component of the current block, so that the prediction of the chroma component of the current block is inaccurate by the weighted prediction method, thereby reducing the encoding efficiency.

Based on this, the embodiments of the present application provide an encoding method and a decoding method. After determining prediction parameters of the current block, a first prediction block of the current block is determined according to the prediction parameters; and then model parameters are determined according to a first color component value and a second color component value of the first prediction block. The model parameters sufficiently reflect the correlation between luma and chroma of the prediction block, and the correlation is applied to existing luma information of the current block for chroma prediction, so that the accuracy of inter chroma prediction may be improved and bit rate may be saved, and the coding efficiency may also be improved, thereby improving coding performance.

The embodiments of the present application will be described in detail below in conjunction with the accompanying drawings.

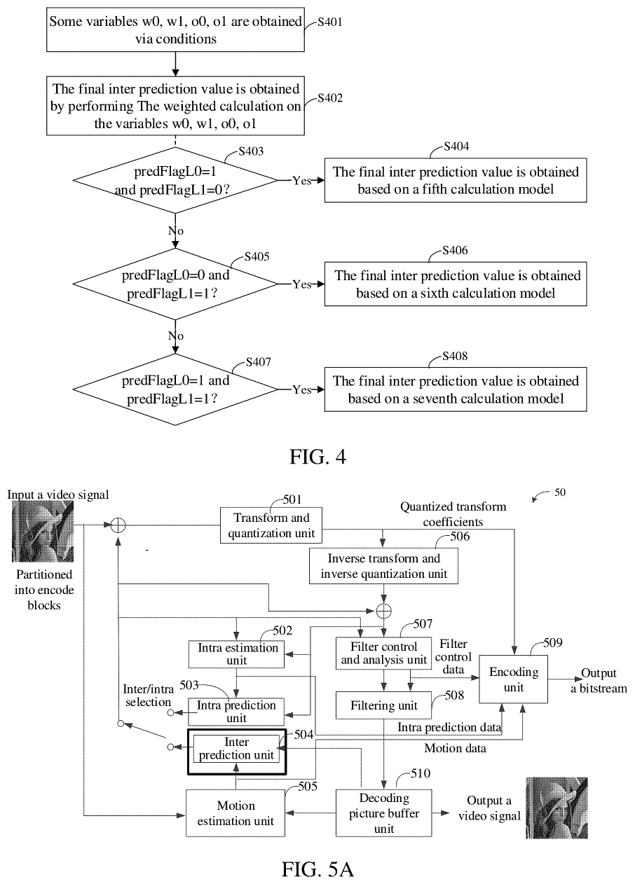

Referring to FIG. 5A, which shows a schematic composition block diagram of an encoder provided by the embodiments of the present application. As shown in FIG. 5A, the encoder (specifically “video encoder”) 50 may include a transform and quantization unit 501, an intra estimation unit 502, an intra prediction unit 503, an inter prediction unit 504, a motion estimation unit 505, an inverse transform and inverse quantization unit 506, a filter control analysis unit 507, a filtering unit 508, an encoding unit 509 and a decoding picture buffer unit 510, etc. The filtering unit 508 may implement deblocking filtering and sample adaptive offset (SAO) filtering, and the encoding unit 509 may implement header information coding and context-based adaptive binary arithmetic coding (CABAC). For an input original video signal, a video encoding block may be obtained by partitioning the coding tree unit (CTU), and then residual sample information obtained after intra prediction or inter prediction is transformed by the transform and quantization unit 501, including transforming the residual information from a sample domain to a transform domain, and quantizing the obtained transform coefficients to further reduce the bit rate. The intra estimation unit 502 and the intra prediction unit 503 are used to perform intra prediction on the video encoding block; optionally, the intra estimation unit 502 and the intra prediction unit 503 are used to determine the intra prediction mode to be used to encode the video encoding block. The inter prediction unit 504 and the motion estimation unit 505 are used to perform inter prediction coding of the received video encoding block relative to one or more blocks in one or more reference pictures to provide temporal prediction information. The motion estimation performed by the motion estimation unit 505 is a process of generating a motion vector, and the motion vector may estimate the motion of the video encoding block, and then the inter prediction unit 504 performs motion compensation based on the motion vector determined by the motion estimation unit 505, so that the inter prediction unit 504 may also be called motion compensation unit. After determining the intra prediction mode, the intra prediction unit 503 is further used to provide selected intra prediction data to the encoding unit 509, and the motion estimation unit 505 further sends the calculated motion vector data to the encoding unit 509. In addition, the inverse transform and inverse quantization unit 506 is used to reconstruct the video encoding block, which includes: reconstructing the residual block in the sample domain, and providing the reconstructed residual block to the filter control analysis unit 507 and the filtering unit 508 to remove blocking artifacts, and adding the reconstructed residual block to a prediction block in a picture in the decoding picture buffer unit 510, to generate a reconstructed video encoding block. The encoding unit 509 is used to encode various coding parameters and quantized transform coefficients. In the CABAC-based encoding algorithm, context content may be based on adjacent encoding blocks and may further be used to encode information indicating the determined intra prediction mode and output a bitstream of the video signal. The decoding picture buffer unit 510 is used to store the reconstructed video encoding block for prediction reference. As the video picture encoding progresses, new reconstructed video encoding blocks are generated continuously, and the reconstructed video encoding blocks are stored in the decoding picture buffer unit 510.

Referring to FIG. 5B, which shows a schematic composition block diagram of a decoder provided by the embodiments of the present application. As shown in FIG. 5B, the decoder (specifically, a “video decoder”) 60 includes a decoding unit 601, an inverse transform and inverse quantization unit 602, an intra prediction unit 603, an inter prediction unit 604, a filtering unit 605, and a decoding picture buffer unit 606, etc. The decoding unit 601 may implement header information decoding and CABAC decoding, and the filtering unit 605 may implement deblocking filtering and SAO filtering. After the input video signal is encoded in FIG. 5A, a bitstream of the video signal is output; the bitstream is input to the decoder 60, and first passes through the decoding unit 601 to obtain the decoded transform coefficients. The transform coefficients are processed by the inverse transform and inverse quantization unit 602, to generate residual blocks in the sample domain. The intra prediction unit 603 may be used to generate prediction data for the current video decoding block based on the determined intra prediction mode and the data from the previously decoded block of the current frame or picture. The inter prediction unit 604 is used to determine the prediction information for the video decoding block by parsing the motion vector and other associated syntax elements, and generate the prediction block of the video decoding block being decoded using the prediction information. The decoded video block is formed by summing the residual block from the inverse transform and inverse quantization unit 602 and the corresponding prediction block generated by the intra prediction unit 603 or the inter prediction unit 604. The decoded video signal passes through the filtering unit 605 to remove the blocking artifacts, which may improve the video quality; the decoded video block is then stored in the decoding picture buffer unit 606, which stores the reference picture used for subsequent intra prediction or motion compensation, and is also used for the output of the video signal, that is, the restored original video signal is obtained.

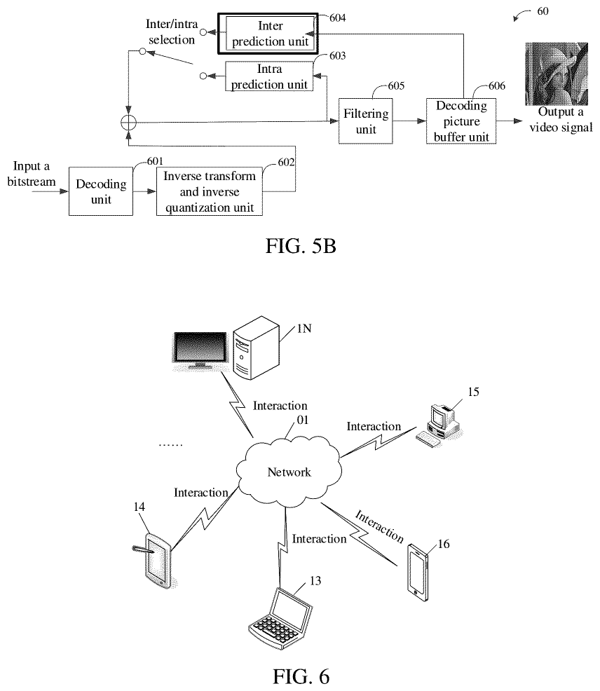

Furthermore, the embodiments of the present application further provide a network architecture of a coding system including an encoder and a decoder. FIG. 6 is a schematic diagram of a network architecture of a coding system provided by the embodiments of the present application. As shown in FIG. 6, the network architecture includes one or more electronic devices 13 to IN and a communication network 01, where the electronic devices 13 to IN may perform video interaction via the communication network 01. During the implementation process, the electronic devices may be various types of devices with video coding functions. For example, the electronic device may include a smart phone, a tablet computer, a personal computer, a personal digital assistant, a navigator, a digital phone, a video phone, a television, a sensor device, a server, or the like, which is not limited in the embodiments of the present application. Here, the decoder or encoder described in the embodiments of the present application may be the above-mentioned electronic device.

It should be noted that, the methods in the embodiments of the present application are mainly applied to the inter prediction unit 504 shown in FIG. 5A and the inter prediction unit 604 shown in FIG. 5B. That is to say, the embodiments of the present application may be applied to both encoder and decoder, and may even be applied to both encoder and decoder, which is not limited in the embodiments of the present application.

It should also be noted that, in a case of applying to the inter prediction unit 504, the “current block” specifically refers to an encoding block on which inter prediction is to be performed currently; in a case of applying to the inter prediction unit 604, the “current block” specifically refers to a decoding block on which inter prediction is to be performed currently.

In a first clause, the present application provides a decoding method, which includes:
decoding a bitstream to determine prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a reconstructed value of the second color component sample of the current block according to the prediction value of the second color component sample of the current block.

In a second clause, according to the first clause, the prediction parameters include:
a motion vector, a reference picture index, and an inter prediction flag parameter, where the inter prediction flag parameter indicates a prediction mode used for decoding the current block, and the prediction mode includes List0 prediction, List1 prediction, and bi-prediction.

In a third clause, according to the second clause, the method further includes: the inter prediction flag parameter indicating that the prediction mode used for decoding the current block is the bi-prediction.

In a fourth clause, according to the second clause, the method further includes:
determining, a List0 prediction block of the current block, a List1 prediction block of the current block according to the prediction parameters.

In a fifth clause, according to the fourth clause, the method further includes:
the first prediction block being the List0 prediction block of the current block; or
the first prediction block being the List1 prediction block of the current block; or
the first prediction blocks including the List0 prediction block of the current block and
the List1 prediction block of the current block.

In a sixth clause, according to the fifth clause, determining the model parameters according to the first color component value and the second color component value of the first prediction block includes:
the model parameters including coefficients of a target filter.

In a seventh clause, according to the sixth clause, the method further includes:
determining the coefficients of the target filter according to the first color component value and the second color component value of the first prediction block.

In an eighth clause, according to the sixth clause, the method further includes:
the coefficients of the target filter are coefficients used by the target filter in a case where a first error between an output value of the second color component value of the first prediction block processed by the target filter and an output value of the first color component value of the first prediction block processed by the target filter meets a first condition.

In a ninth clause, according to the eighth clause, the method further includes:
the first condition being that the first error is minimum.

In a tenth clause, according to the eighth clause, the method further includes:
the first condition being that the first error is within a first preset threshold range.

In an eleventh clause, according to the eighth clause, the method further includes:
the first condition being that a variation of the first error is within a second preset threshold range.

In a twelfth clause, according to the seventh clause, determining the coefficients of the target filter according to the first color component value and the second color component value of the first prediction block includes:
determining autocorrelation parameters according to the first color component value of the first prediction block;
determining cross-correlation parameters according to the first color component value and the second color component value of the first prediction block; and
determining the coefficients of the target filter according to the autocorrelation parameters and the cross-correlation parameters.

In a thirteenth clause, according to the sixth clause, the method further includes:
the number of the coefficients of the target filter being equal to a first preset constant value.

In a fourteenth clause, according to the sixth clause, the method further includes:
decoding the bitstream to determine the number of coefficients of the target filter.

In a fifteenth clause, according to the fourteenth clause, the method further includes:
determining first flag information of a block category of the current block; and
determining the number of coefficients of the target filter according to the first flag information of the block category of the current block.

In a sixteenth clause, according to the sixth clause, the method further includes:
the target filter being a one-dimensional or two-dimensional filter with a preset shape.

In a seventeenth clause, according to the sixth clause, the method further includes:
decoding the bitstream to determine a shape of the target filter.

In an eighteenth clause, according to the seventeenth clause, the method further includes:
determining a value of a filter shape parameter, where the filter shape parameter indicates the shape of the target filter.

In a nineteenth clause, according to the eighteenth clause, the method further includes:
determining second flag information of a block category of the current block; and
determining the value of the filter shape parameter according to the second flag information of the block category of the current block.

In a twentieth clause, according to the first clause, where determining the reference sample value of the first color component sample of the current block includes:
determining the reference sample value of the first color component sample of the current block according to a reconstructed value of the first color component sample of the current block.

In a twenty-first clause, according to the twentieth clause, the method further includes:
determining the reconstructed value of the first color component sample of the current block according to the first color component value of the first prediction block.

In a twenty-second clause, according to the twenty-first clause, determining the reconstructed value of the first color component sample of the current block according to the first color component value of the first prediction block includes:
determining the reconstructed value of the first color component sample of the current block according to a first color component value of a List0 prediction block of the current block and a first color component value of a List1 prediction block of the current block.

In a twenty-third clause, according to the first clause, determining the reference sample value of the first color component sample of the current block includes:
determining a prediction value of the first color component sample of the current block according to the first color component value of the first prediction block; and
determining the reference sample value of the first color component sample of the current block according to the prediction value of the first color component sample of the current block.

In a twenty-fourth clause, according to the twenty-third clause, determining the prediction value of the first color component sample of the current block according to the first color component value of the first prediction block includes:
determining the prediction value of the first color component sample of the current block according to the first color component value of a List0 prediction block of the current block and the first color component value of a List1 prediction block of the current block.

In a twenty-fifth clause, according to the twenty-fourth clause, the method further includes:
determining a List0 weighting factor of the List0 prediction block of the current block and a List1 weighting factor of the List1 prediction block of the current block;
determining, according to the List0 weighting factor and the List1 weighting factor, a weighted sum of the first color component value of the List prediction block of the current block and the first color component value of the List1 prediction block of the current block; and
determining the prediction value of the first color component sample of the current block according to the weighted sum.

In a twenty-sixth clause, according to the sixth clause, determining the prediction value of the second color component sample of the current block according to the reference sample value of the first color component sample of the current block and the model parameters includes:
determining a first input value of the target filter based on the reference sample value of the first color component sample of the current block;
determining a first output value of the target filter based on the first input value and the model parameters; and
determining the prediction value of the second color component sample of the current block based on the first output value.

In a twenty-seventh clause, according to the twenty-sixth clause, determining the first input value of the target filter according to the reference sample value of the first color component sample of the current block includes:
performing a first filtering process on the reference sample value of the first color component sample of the current block, to determine the first input value.

In a twenty-eighth clause, according to the twenty-seventh clause, the method further includes:
the first filtering process including at least one of: low-pass filtering, or down-sampling filtering.

In a twenty-ninth clause, according to the twenty-seventh clause, the method further includes:
setting, by the first filtering process, the first input value to be equal to the reference sample value of the first color component sample of the current block.

In a thirtieth clause, according to the twenty-sixth clause, determining the prediction value of the second color component sample of the current block based on the first output value further includes:
performing a second filtering process on the first output value, to determine a second output value; and
determining the prediction value of the second color component sample of the current block based on the second output value.

In a thirty-first clause, according to the thirtieth clause, the method further includes:
the second filtering process including at least one of: low-pass filtering, or up-sampling filtering.

In a thirty-second clause, according to the thirtieth clause, the method further includes:
setting, by the second filtering process, the second output value to be equal to the first output value.

In a thirty-third clause, according to the thirtieth clause, the method further includes:
the first output value including a prediction value of a portion of the second color component sample of the current block.

In a thirty-fourth clause, according to the thirtieth clause, determining the prediction value of the second color component sample of the current block based on the second output value includes:
performing a first process on the second output value, to obtain the prediction value of the second color component sample of the current block.

In a thirty-fifth clause, according to the thirty-fourth clause, the method further includes:
the first process being a clip operation that restricts the second output value within a preset value range.

In a thirty-sixth clause, according to the twenty-sixth clause, determining the prediction value of the second color component sample of the current block based on the first output value further includes:
performing an additive operation according to the first output value and a first offset value, to determine the prediction value of the second color component sample of the current block.

In a thirty-seventh clause, according to the thirty-sixth clause, the method further includes:
setting the first offset value to be equal to a preset constant value; or
setting the first offset value to be equal to a value of the first input value in a preset mapping relationship.

In a thirty-eighth clause, according to the first clause, the method further includes:
determining a prediction residual value of the first color component sample of the current block; and
determining the reference sample value of the first color component sample of the current block according to the prediction residual value of the first color component sample of the current block.

In a thirty-ninth clause, according to the thirty-eighth clause, the method further includes:
determining a first color component residual value and a second color component residual value of the first prediction block; and
determining the model parameters according to the first color component residual value and the second color component residual value of the first prediction block;
correspondingly, determining the prediction value of the second color component sample of the current block according to the reference sample value of the first color component sample of the current block and the model parameters includes:
determining an initial prediction residual value of the second color component sample of the current block according to the prediction residual value of the first color component sample of the current block and the model parameters;
determining, according to the first prediction block, an initial prediction value of the second color component sample of the current block; and
determining the prediction value of the second color component sample of the current block according to the initial prediction residual value and the initial prediction value of the second color component sample of the current block.

In a fortieth clause, according to any one of the first clause to the thirty-ninth clause, determining the reconstructed value of the second color component sample of the current block according to the prediction value of the second color component sample of the current block includes:
decoding the bitstream to determine a prediction residual value of the second color component sample of the current block; and
determining the reconstructed value of the second color component sample of the current block according to the prediction value of the second color component sample of the current block and the prediction residual value of the second color component sample of the current block.

In a forty-first clause, the present application provides a encoding method, which includes:
determining prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a prediction residual value of the second color component sample of the current block according to the prediction value of the second color component sample of the current block.

In a forty-second clause, according to the forty-first clause, determining the prediction residual value of the second color component sample of the current block according to the prediction value of the second color component sample of the current block includes:
determining an initial value of the second color component sample of the current block; and
determining the prediction residual value of the second color component sample of the current block according to the initial value of the second color component sample of the current block and the prediction value of the second color component sample of the current block.

In a forty-third clause, according to the forty-first clause or the forty-second clause, the method further includes:
encoding the prediction residual value of the second color component sample of the current block, and writing the obtained encoded bits into a bitstream.

In a forty-fourth clause, according to the forty-first clause, the method further includes:
encoding the prediction parameters, and writing the obtained encoded bits into the bitstream.

In a forty-fifth clause, according to the forty-first clause, the prediction parameters include:
a motion vector, a reference picture index, and an inter prediction flag parameter, where the inter prediction flag parameter indicates a prediction mode used for encoding the current block, and the prediction mode includes List0 prediction, List1 prediction, and bidirectional prediction.

In a forty-sixth clause, according to the forty-fifth clause, the method further includes: the inter prediction flag parameter indicating that the prediction mode used for encoding the current block is the bidirectional prediction.

In a forty-seventh clause, according to the forty-fifth clause, the method further includes:
determining a List0 prediction block of the current block, a List1 prediction block of the current block according to the prediction parameters.

In a forty-eighth clause, according to the forty-seventh clause, the method further includes:
the first prediction block being the List0 prediction block of the current block; or
the first prediction block being the List1 prediction block of the current block; or
the first prediction blocks including the List0 prediction block of the current block and the List1 prediction block of the current block.

In a forty-ninth clause, according to the forty-eighth clause, determining the model parameters according to the first color component value and the second color component value of the first prediction block includes:
the model parameters including coefficients of a target filter.

In a fiftieth clause, according to the forty-ninth clause, the method further includes:
determining the coefficients of the target filter according to the first color component value and the second color component value of the first prediction block.

In a fifty-first clause, according to the forty-ninth clause, the method further includes:
the coefficients of the target filter being coefficients used by the target filter in a case where a first error between an output value of the second color component value of the first prediction block processed by the target filter and an output value of the first color component value of the first prediction block processed by the target filter meets a first condition.

In a fifty-second clause, according to the fifty-first clause, the method further includes:
the first condition being that the first error is minimum.

In a fifty-third clause, according to the fifty-first clause, t the method further includes:
the first condition being that the first error is within a first preset threshold range.

In a fifty-fourth clause, according to the fifty-first clause, the method further includes:
the first condition being that a variation of the first error is within a second preset threshold range.

In a fifty-fifth clause, according to the fiftieth clause, determining the coefficients of the target filter according to the first color component value and the second color component value of the first prediction block includes:
determining autocorrelation parameters according to the first color component value of the first prediction block;
determining cross-correlation parameters according to the first color component value and the second color component value of the first prediction block; and
determining the coefficients of the target filter according to the autocorrelation parameters and the cross-correlation parameters.

In a fifty-sixth clause, according to the forty-ninth clause, the method further includes:
determining the number of the coefficients of the target filter.

In a fifty-seventh clause, according to the fifty-sixth clause, the method further includes:
encoding the number of the coefficients of the target filter, and writing the obtained encoded bits into the bitstream.

In a fifty-eighth clause, according to the fifty-sixth clause, determining the number of coefficients of the target filter includes:
the number of the coefficients of the target filter being equal to a first preset constant value.

In a fifty-ninth clause, according to the fifty-sixth clause, determining the number of coefficients of the target filter includes:
determining first flag information of a block category of the current block; and
determining the number of coefficients of the target filter according to the first flag information of the block category of the current block.

In a sixtieth clause, according to the fifty-ninth clause, the method further includes:
encoding the first flag information of the block category of the current block, and writing the obtained encoded bits into the bitstream.

In a sixty-first clause, according to the forty-ninth clause, the method further includes:
the target filter being a one-dimensional or two-dimensional filter with a preset shape.

In a sixty-second clause, according to the forty-ninth clause, the method further includes:
determining a shape of the target filter.

In a sixty-third clause, according to the sixty-second clause, the method further includes:
encoding the shape of the target filter, and writing the obtained encoded bits into the bitstream.

In a sixty-fourth clause, according to the sixty-second clause, determining the shape of the target filter includes:
determining a value of a filter shape parameter, where the filter shape parameter indicates the shape of the target filter.

In a sixty-fifth clause, according to the sixty-fourth clause, the method further includes:
determining second flag information of a block category of the current block; and
determining the value of the filter shape parameter according to the second flag information of the block category of the current block.

In a sixty-sixth clause, according to the sixty-fourth clause, the method further includes:
encoding the value of the filter shape parameter, and writing the obtained encoded bits into the bitstream.

In a sixty-seventh clause, according to the sixty-fifth clause, the method further includes:
encoding the second flag information of the block category of the current block, and writing the obtained encoded bits into the bitstream.

In a sixty-eighth clause, according to the forty-first clause, determining the reference sample value of the first color component sample of the current block includes:
determining the reference sample value of the first color component sample of the current block according to a reconstructed value of the first color component sample of the current block.

In a sixty-ninth clause, according to the sixty-eighth clause, the method further includes:
determining the reconstructed value of the first color component sample of the current block according to the first color component value of the first prediction block.

In a seventieth clause, according to the sixty-ninth clause, determining the reconstructed value of the first color component sample of the current block according to the first color component value of the first prediction block includes:
determining the reconstructed value of the first color component sample of the current block according to a first color component value of a List0 prediction block of the current block and a first color component value of a List1 prediction block of the current block.

In a seventy-first clause, according to the forty-first clause, determining the reference sample value of the first color component sample of the current block includes:
determining a prediction value of the first color component sample of the current block according to the first color component value of the first prediction block; and
determining the reference sample value of the first color component sample of the current block according to the prediction value of the first color component sample of the current block.

In a seventy-second clause, according to the seventy-first clause, determining the prediction value of the first color component sample of the current block according to the first color component value of the first prediction block includes:
determining the prediction value of the first color component sample of the current block according to the first color component value of a List0 prediction block of the current block and the first color component value of a List1 prediction block of the current block.

In a seventy-third clause, according to the seventy-second clause, the method further includes:
determining a List0 weighting factor of the List0 prediction block of the current block and a List1 weighting factor of the List1 prediction block of the current block;
determining, according to the List0 weighting factor and the List1 weighting factor, a weighted sum of the first color component value of the List0 prediction block of the current block and the first color component value of the List1 prediction block of the current block; and
determining the prediction value of the first color component sample of the current block according to the weighted sum.

In a seventy-fourth clause, according to the forty-ninth clause, determining the prediction value of the second color component sample of the current block according to the reference sample value of the first color component sample of the current block and the model parameters includes:
determining a first input value of the target filter based on the reference sample value of the first color component sample of the current block;
determining a first output value of the target filter based on the first input value and the model parameters; and
determining the prediction value of the second color component sample of the current block based on the first output value.

In a seventy-fifth clause, according to the seventy-fourth clause, determining the first input value of the target filter according to the reference sample value of the first color component sample of the current block includes:
performing a first filtering process on the reference sample value of the first color component sample of the current block, to determine the first input value.

In a seventy-sixth clause, according to the seventy-fifth clause, the method further includes:
the first filtering process including at least one of: low-pass filtering, or down-sample filtering.

In a seventy-seventh clause, according to the seventy-fifth clause, the method further includes:
setting, by the first filtering process, the first input value to be equal to the reference sample value of the first color component sample of the current block.

In a seventy-eighth clause, according to the seventy-fourth clause, determining the prediction value of the second color component sample of the current block based on the first output value further includes:
performing a second filtering process on the first output value, to determine a second output value; and
determining the prediction value of the second color component sample of the current block based on the second output value.

In a seventy-ninth clause, according to the seventy-eighth clause, the method further includes:
the second filtering process including at least one of: low-pass filtering, or up-sampling filtering.

In an eightieth clause, according to the seventy-eighth clause, the method further includes:
setting, by the second filtering process, the second output value to be equal to the first output value.

In an eighty-first clause, according to the seventy-eighth clause, the method further includes:
the first output value including a prediction value of a portion of the second color component sample of the current block.

In an eighty-second clause, according to the seventy-eighth clause, determining the prediction value of the second color component sample of the current block based on the second output value includes:
performing a first process on the second output value, to obtain the prediction value of the second color component sample of the current block.

In an eighty-third clause, according to the eighty-second clause, the method further includes:
the first process being a clip operation that restricts the second output value within a preset value range.

In an eighty-fourth clause, according to the seventy-fourth clause, determining the prediction value of the second color component sample of the current block based on the first output value further includes:
performing an additive operation according to the first output value and a first offset value, to determine the prediction value of the second color component sample of the current block.

In an eighty-fifth clause, according to the eighty-fourth clause, the method further includes:
setting the first offset value to be equal to a preset constant value; or
setting the first offset value to be equal to a value of the first input value in a preset mapping relationship.

In an eighty-sixth clause, according to any of the forty-first clause to the eighty-fifth clause, where the method further includes:
determining a prediction residual value of the first color component sample of the current block; and
determining the reference sample value of the first color component sample of the current block according to the prediction residual value of the first color component sample of the current block.

In an eighty-seventh clause, according to the seventy-sixth clause, the method further includes:
determining a first color component residual value and a second color component residual value of the first prediction block; and
determining the model parameters according to the first color component residual value and the second color component residual value of the first prediction block;
correspondingly, determining the prediction value of the second color component sample of the current block according to the reference sample value of the first color component sample of the current block and the model parameters includes:
determining an initial prediction residual value of the second color component sample of the current block according to the prediction residual value of the first color component sample of the current block and the model parameters;
determining, according to the first prediction block, an initial prediction value of the second color component sample of the current block; and
determining the prediction value of the second color component sample of the current block according to the initial prediction residual value and the initial prediction value of the second color component sample of the current block.

In an eighty-eighth clause, the present application provides a bitstream, where the bitstream is generated by bit encoding according to information to be encoded, and the information to be encoded includes at least one of:
a prediction residual value of a second color component sample of a current block, prediction parameters of the current block, the number of coefficients of a target filter, a shape of the target filter, a value of a filter shape parameter, first flag information of a block category of the current block, or second flag information of the block category of the current block.

In an eighty-ninth clause, the present application provides a decoder, which includes a second memory and a second processor; where
the second memory is configured to store a computer program that is able to be run on the second processor; and
the second processor, is configured to perform the method according to any one of the first clause to the fortieth clause.

In a ninetieth clause, the present application provides an encoder, which includes: a first memory and a first processor; where
the first memory is configured to store a computer program that is able to be run on the first processor; and
the first processor is configured to perform the method according to any one of the forty-first clause to the eighty-seventh clause when running the computer program.

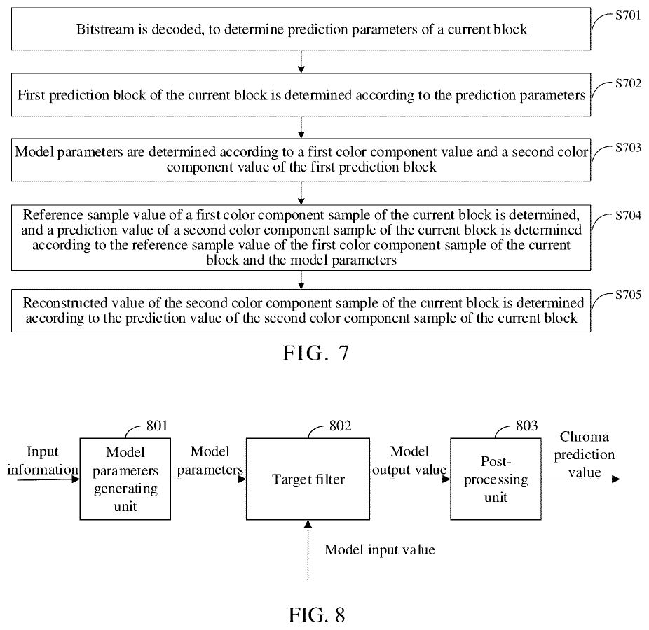

In an embodiment of the present application, referring to FIG. 7, a schematic flowchart of a decoding method provided by the embodiments of the present application is illustrated. As shown in FIG. 7, the method may include following contents.

S701, a bitstream is decoded to determine prediction parameters of a current block.

It should be noted that the decoding method of the embodiments of the present application is applied to a decoder. In addition, the decoding method may specifically refer to an inter prediction method, and more specifically, an inter chroma prediction method. In an inter prediction process, a chroma prediction based on convolutional cross-component model (CP-CCCM) technology is proposed herein, which is capable of improving the accuracy of chroma prediction.

In the embodiments of the present application, a video picture may be partitioned into multiple decoding blocks, each decoding block may include a first color component, a second color component and a third color component, and the current block in the embodiments of the present application refers to a decoding block of the video picture on which inter prediction to be performed currently.

Here, in a case where the prediction needs to be performed on the first color component of the current block, and the first color component is a luma component, the current block may also be called a luma block; or, in a case where the prediction needs to be performed on the second color component of the current block, and the second color component is a chroma component, the current block may also be called a chroma block.

It should also be noted that, in the embodiments of the present application, the prediction parameters of the current block need to be determined first. At the decoding end, it may be obtained directly by decoding the bitstream. In some embodiments, the prediction parameters may include: a motion vector, a reference picture index, and an inter prediction flag parameter.

The reference picture index indicates whether the reference picture used by the current block is List0 or List1; the inter prediction flag parameter indicates a prediction mode used for decoding the current block, and the prediction mode may include List0 prediction, List1 prediction, and bidirectional prediction (bi-prediction).

It should be understood that, in the embodiments of the present application, List0 indicates (specifies) reference picture list 0, which may also be called a forward reference picture; the List1 indicates (specifies) reference picture list 1, which may also be called a backward reference picture.

For List0 prediction, a flag value of which inter prediction is performed using reference picture list 0 is equal to 1, and a flag value of which inter prediction is performed using reference picture list 1 is equal to 0. For example, the forward prediction.

For List1 prediction, a flag value of which inter prediction is performed using reference picture list 0 is equal to 0, and a flag value of which inter prediction is performed using reference picture list 1 is equal to 1. For example, the backward prediction.

For bi-prediction, a flag value of which inter prediction is performed using reference picture list 0 is equal to 1, and a flag value of which inter prediction is performed using reference picture list 1 is equal to 1. For example, the forward prediction and the backward prediction.

In the embodiments of the present application, the inter prediction flag parameter may indicate that the prediction mode used for decoding the current block is the bi-prediction.

Exemplarily, if the bi-prediction is used for the current block, the inter prediction flag parameter may indicate that the prediction mode used for decoding the current block is the bi-prediction. Otherwise, if the List0 prediction or List1 prediction is used for the current block, the inter prediction flag parameter may indicate that the prediction mode used for decoding the current block is unidirectional prediction (uni-prediction). The prediction mode used for the current block is set according to actual conditions, which is not limited in the embodiments of the present application.

Exemplarily, the reference picture index may be represented by inter_pred_idc, and the prediction list usage flag information may be represented by predFlagLX. If X equals to 0 (X=0), i.e., predFlagL0 equals to 0 (predFlagL0=1), the reference picture List0 may be used for the uni-prediction; if X equals to 1 (X=1), i.e., predFlagL1 equals to 1 (predFlagL1=1), the reference picture List1 may be used for the uni-prediction; if predFlagL0=1 and predFlagL1=1, then reference picture List0 and reference picture List1 may be used for the bi-prediction. That is, in the embodiments of the present application, the problem of prediction direction may be expanded from being determined according to inter_pred_idc to being determined according to practical predFlagLX. The reason is that, in some modes such as merge, skip, whether the uni-prediction or the bi-prediction is used for the current block is determined according to whether merge candidate (mergeCand) is the uni-prediction or the bi-prediction.

S702, a first prediction block of the current block is determined according to the prediction parameters.

In the embodiments of the present application, the first prediction block of the current block, such as a List0 prediction block or a List1 prediction block, may be determined based on information obtained by decoding, such as the motion vector, the reference picture index, or the inter prediction flag parameter. Therefore, in some embodiments, the method may further include: determining the List0 prediction block of the current block, the List1 prediction block of the current block according to the prediction parameters.

Exemplarily, in a case where the prediction parameters include the motion vector, the first prediction block of the current block may be determined according to the motion vector. In a case where the prediction parameters include a first motion vector (e.g., a forward motion vector), the List0 prediction block of the current block may be determined according to the first motion vector; and/or, in a case where the prediction parameters include a second motion vector (e.g., a backward motion vector), the List1 prediction block of the current block may be determined according to the second motion vector.

That is, the List0 prediction block may be determined from the List0 reference picture according to the first motion vector, and the List1 prediction block may be determined from the List1 reference picture according to the second motion vector.

In an embodiment, the first prediction block is the List0 prediction block of the current block; or, the first prediction block is the List1 prediction block of the current block; or, the first prediction blocks includes the List0 prediction block of the current block and the List1 prediction block of the current block.

It should be noted that, for the uni-prediction, the first prediction block may be the List0 prediction block of the current block, i.e., the forward matching block; or, the first prediction block may be the List1 prediction block of the current block, i.e., the backward matching block.

It should also be noted that, for the bi-prediction, the first prediction block may include the List0 prediction block of the current block and the List1 prediction block of the current block. In this case, a prediction value of the bi-prediction is equal to a sum of the product of w0 and predList0 and the product of w1 and predList1 (i.e., predBI=w0×predList0+w1×predList1), where w0 and w1 indicate weighted values.

It should be understood that, in the embodiments of the present application, a value of the reference picture index is associated with flag information (represented by cpcccmSizeId) of a block category of the current block. In some embodiments, the method may further include: determining flag information of the block category of the current block; and determining a value of the reference picture index according to the flag information of the block category of the current block.

It should also be understood that, in the embodiments of the present application, the flag information of the block category of the current block may be determined by decoding the bitstream, or may be determined according to size parameters of the current block.

Exemplarily, in response to that a value of cpcccmSizeId is equal to 0, the value of the reference picture index is determined to be 1; in response to that the value of cpcccmSizeId is equal to 1, the value of the reference picture index is determined to be 0; in response to that the value of cpcccmSizeId is equal to 2, the value of the reference picture index is determined to be 2. Alternatively, in response to that the value of cpcccmSizeId is equal to 0, the value of the reference picture index is determined to be 0; in response to that the value of cpcccmSizeId is equal to 1, the value of the reference picture index is determined to be 0; in response to that the value of cpcccmSizeId is equal to 2, the value of the reference picture index is determined to be 0.

In an embodiment, the first prediction block of the current block may also be determined according to the value of the reference picture index. Accordingly, the method may further include: in response to that the value of the reference picture index is a first value, determining that the first prediction block is the List0 prediction block of the current block; or, in response to that the value of the reference picture index is a second value, determining that the first prediction block is the List1 prediction block of the current block; or, in response to that the value of the reference picture index is a third value, determining that the first prediction block includes the List0 prediction block of the current block and the List1 prediction block of the current block.

Exemplarily, the reference picture index may be represented by inter_pred_idc. Assuming that the first value, the second value and the third value are set to 0, 1, and 2 respectively, in a case where a value of inter_pred_idc is 0, the first prediction block may be the List0 prediction block; in a case where the value of inter_pred_idc is 1, the first prediction block may be the List1 prediction block; in a case where the value of inter_pred_idc is 2, the first prediction block includes the List0 prediction block and the List1 prediction block.

S703, model parameters are determined according to a first color component value and a second color component value of the first prediction block.

In the embodiments of the present application, after determining the first prediction block of the current block, the first color component value and the second color component value of the first prediction block may be obtained. The first color component value and the second color component value are both reconstructed information; the model parameters may be calculated according to the first color component value and the second color component value of the first prediction block.

In the embodiments of the present application, the model parameters are determined according to the first color component value and the second color component value of the first prediction block, and the model parameters here may include coefficients of a target filter. Therefore, in some embodiments, the method may include: determining the coefficients of the target filter according to the first color component value and the second color component value of the first prediction block.

In an embodiment, the coefficients of the target filter may be determined by solving the optimization problem. Accordingly, the method may further include that the coefficients of the target filter are coefficients used by the target filter in a case where a first error between an output value of the second color component value of the first prediction block processed by the target filter and an output value of the first color component value of the first prediction block processed by the target filter meets a first condition.

It should be understood that, for the first error to meet the first condition, in a possible implementation, the first condition is that the first error is minimum. Alternatively, in another possible implementation, the first condition is that the first error is within a first preset threshold range. Alternatively, in yet another possible implementation, the first condition is that a variation of the first error is within a second preset threshold range.

It should also be understood that the first preset threshold range and the second preset threshold range are both determining standards preset by the decoding end for determining whether the first error meets the first condition. In addition, the first error may be a mean square error (MSE), or a sum of squared error (SSE), or a sum of absolute error (SAD), or a sum of absolute difference after Hadamard transform (sum of absolute transformed difference, SATD), or a mean absolute error (MAE), etc., which is not limited in the embodiments of the present application.

In the embodiments of the present application, the first color component value of the first prediction block may refer to a luma reconstructed value of the first prediction block, where the luma reconstructed value of sample i may be indicated by refrecY[i]. The second color component value of the first prediction block may refer to a chroma reconstructed value of the first prediction block, where the chroma reconstructed value of sample i may be indicated by refrecC[i].

In this way, after obtaining the luma reconstructed value and the chroma reconstructed value of the first prediction block, a set of coefficients of the target filter may be derived by minimizing an MSE between the chroma reconstructed value and the chroma value predicted by CP-CCCM, that is:

$$MSE = E [ {( refpredC [ i ] - refrecC [ i ] )}^{2} ] = E [ {( {\sum }_{n = 0}^{nTap - 1} {c}_{n} \cdot refrecY [ i ] - refrecC [ i ] )}^{2} ] \qquad ( 12 )$$

here, i=0, 1, 2, . . . , predSizeW×predSizeH−1, refpredC [i] indicates the chroma value predicted by CP-CCCM, cₙ indicates the coefficients of the target filter, n indicates a coefficient serial number, and n=0, 1, . . . , nTap−1, nTap is the number of coefficients of the target filter.

Furthermore, the coefficients of the target filter are derived by minimizing the MSE. The process is as follows.

First, take the partial derivative of cₙ and make it equal to 0, that is:

$$\frac{\partial MSE}{\partial {c}_{m}} = E [ 2 ( {\sum }_{n = 0}^{nTap - 1} {c}_{n} \cdot refrecY [ i ] - refrecC [ i ] ) \cdot refrecY [ i ] ] , \\ m = 0 , 1 , ... , nTap - 1 \qquad ( 13 )$$

$$E [ 2 ( {\sum }_{n = 0}^{nTap - 1} {c}_{n} \cdot refrecY [ i ] - refrecC [ i ] ) \cdot refrecY [ i ] ] = 0 \qquad ( 14 )$$

Secondly, according to formula (14), it is obtained that:

$${\sum }_{n = 0}^{nTap - 1} {c}_{n} \cdot E ( refrecY [ i ] \cdot refrecY [ i ] ) = E ( refrecC [ i ] \cdot refrecY [ i ] ) \qquad ( 15 )$$

In another embodiment, determining the coefficients of the target filter according to the first color component value and the second color component value of the first prediction block may include:
determining autocorrelation parameters according to the first color component value of the first prediction block;
determining cross-correlation parameters according to the first color component value and the second color component value of the first prediction block; and
determining the coefficients of the target filter according to the autocorrelation parameters and the cross-correlation parameters.

It should be noted that, the autocorrelation parameters are determined according to the first color component value in the first prediction block. Here, the autocorrelation parameters may be represented by A, and the calculation formula of A is as follows:

$$A = [ \begin{matrix}{\sum }_{i ∈ R} ( refrecY [ i ] [ 0 ] \cdot refrecY [ i ] [ 0 ] ) & {\sum }_{i ∈ R} ( refrecY [ i ] [ 1 ] \cdot refrecY [ i ] [ 0 ] ) & … & {\sum }_{i ∈ R} ( refrecY [ i ] [ nTap - 1 ] \cdot refrecY [ i ] [ 0 ] ) \\ {\sum }_{i ∈ R} ( refrecY [ i ] [ 0 ] \cdot refrecY [ i ] [ 1 ] ) & {\sum }_{i ∈ R} ( refrecY [ i ] [ 1 ] \cdot refrecY [ i ] [ 1 ] ) & … & {\sum }_{i ∈ R} ( refrecY [ i ] [ nTap - 1 ] \cdot refrecY [ i ] [ 1 ] ) \\ ⋮ & ⋮ & ⋱ & ⋮ \\ {\sum }_{i ∈ R} ( refrecY [ i ] [ 0 ] \cdot refrecY [ i ] [ nTap - 1 ] ) & {\sum }_{i ∈ R} ( refrecY [ i ] [ 1 ] \cdot refrecY [ i ] [ nTap - 1 ] ) & … & {\sum }_{i ∈ R} ( refrecY [ i ] [ nTap - 1 ] \cdot refrecY [ i ] [ nTap - 1 ] )\end{matrix} ] \qquad ( 16 )$$

According to the first color component value and the second color component value in the first prediction block, cross-correlation parameters are determined. Here, the cross-correlation parameters may be represented by B, and the calculation formula of B is as follows:

$$B = [ \begin{matrix}{\sum }_{i ∈ R} ( refrecC [ i ] \cdot refrecY [ i ] [ 0 ] ) \\ {\sum }_{i ∈ R} ( refrecC [ i ] \cdot refrecY [ i ] [ 1 ] ) \\ ⋮ \\ {\sum }_{i ∈ R} ( refrecC [ i ] \cdot refrecY [ i ] [ nTap - 1 ] )\end{matrix} ] \qquad ( 17 )$$

It should also be noted that the coefficients of the target filter are determined according to the autocorrelation parameters and the cross-correlation parameters. Here, the coefficients of the target filter may be represented by cₙ, and the relationship among A, B and cₙ is as follows:

$$A \times [ \begin{matrix}{c}_{0} \\ {c}_{1} \\ ⋮ \\ {c}_{nTap - 1}\end{matrix} ] = B \qquad ( 18 )$$

By solving formula (18), the coefficients of the target filter may be obtained as follows:

$$[ \begin{matrix}{c}_{0} \\ {c}_{1} \\ ⋮ \\ {c}_{nTap - 1}\end{matrix} ] = {A}^{- 1} \times B \qquad ( 19 )$$

In this way, according to the determined first prediction block (reference block region), formula (15) is expanded into a matrix form, as shown in formula (18). By solving the system of linear equations shown in formula (18), a set of coefficients of the target filter may be obtained, such that the MSE between the expected output after filtering, i.e., the chroma value predicted by CP-CCCM and the chroma reconstructed value of the expected output is minimum, i.e., Wiener filtering coefficients, which are a set of coefficients of the target filter for the current block.

In the process of solving the system of linear equations, the autocorrelation parameters of the luma reconstructed samples refRecY of the first prediction block are first calculated, the cross-correlation parameters of the luma reconstructed samples refRecY and the chroma reconstruction samples refRecC of the first prediction block are calculated, and then, the autocorrelation parameters are subjected to Cholesky decomposition or LDL decomposition; finally, each target filter coefficient cₙ is calculated in sequence by reverse recursion.

In the embodiments of the present application, for the target filter, it is further necessary to determine the number of coefficients of the target filter and the shape of the target filter. The number of coefficients of the target filter and the shape of the target filter may be preset fixed values, or may be directly determined by the decoded bitstream.

In some embodiments, for the number of coefficients of the target filter, the number of coefficients of the target filter is equal to a first preset constant value.

In some embodiments, for the number of coefficients of the target filter, the method may further include: decoding the bitstream to determine the number of coefficients of the target filter.

In some embodiments, for the number of coefficients of the target filter, the method may further include: determining first flag information of a block category of the current block; and determining the number of coefficients of the target filter according to the first flag information of the block category of the current block.

It should be noted that the number of coefficients of the target filter may be represented by nTap. Exemplarily, a value of nTap may be 4, 5, 6, 7, 8, 9, etc., which is not specifically limited thereto.

It should also be noted that the number of coefficients of the target filter may also be called the number of taps of the target filter. Here, the number of coefficients of the target filter may be a preset constant value, or may be determined by decoding the bitstream, or may even be determined according to the first flag information of the block category of the current block.

Exemplarily, in response to that a value of the first flag information of the block category is equal to 0, the value of nTap is determined to be 3; in response to that the value of the first flag information of the block category is equal to 1, the value of nTap is determined to be 5; or in response to that the value of the first flag information of the block category is equal to 2, the value of nTap is determined to be 9. Alternatively, in response to that the value of the first flag information of the block category is equal to 0, the value of nTap is determined to be 4; in response to that the value of the first flag information of the block category is equal to 1, the value of nTap is determined to be 7; or in response to that the value of the first flag information of the block category is equal to 2, the value of nTap is determined to be 9.

In some embodiments, for the shape of the target filter, the target filter is a one-dimensional or two-dimensional filter with a preset shape.

In some embodiments, for the shape of the target filter, the method may further include: decoding the bitstream to determine the shape of the target filter.

In some embodiments, for the shape of the target filter, the method may further include: determining a value of a filter shape parameter, where the filter shape parameter indicates the shape of the target filter.

In some embodiments, for the shape of the target filter, the method may further include: determining second flag information of the block category of the current block; and determining the value of the filter shape parameter according to the second flag information of the block category of the current block.

It should be noted that the filter shape parameter may be represented by FilterIdx, and FilterIdx is used to indicate the shape of the target filter. Exemplarily, the shape of the target filter may be a diamond, a rectangle, a cross, a stripe, even a one-dimensional filter, a two-dimensional filter, which is not specifically limited thereto.

Exemplarily, in response to that a value of FilterIdx is equal to 0, the shape of the target filter is determined to be a diamond; in response to that the value of FilterIdx is equal to 1, the shape of the target filter is determined to be a cross; in response to that the value of FilterIdx is equal to 2, the shape of the target filter is determined to be a rectangle.

It should also be noted that the shape of the target filter may be a preset shape, or may be determined by decoding a bitstream, or may even be determined according to the second flag information of the block category of the current block.

Exemplarily, in response to that a value of the second flag information of the block category is equal to 0, the value of FilterIdx is determined to be 2; in response to that the value of the second flag information of the block category is equal to 1, the value of FilterIdx is determined to be 1; or in response to that the value of the second flag information of the block category is equal to 2, the value of FilterIdx is determined to be 0. Alternatively, in response to that the value of the second flag information of the block category is equal to 0, the value of FilterIdx is determined to be 1; in response to that the value of the second flag information of the block category is equal to 1, the value of FilterIdx is determined to be 2; or in response to that the value of the second flag information of the block category is equal to 2, the value of FilterIdx is determined to be 0.

It should be understood that, in the embodiments of the present application, the second flag information of the block category may be the same as or different from the first flag information of the block category. Exemplarily, in an embodiment, the first flag information of the block category is the same as the second flag information of the block category, that is, single flag information may be used to indicate both the number of coefficients of the target filter and the shape of the target filter.

It should also be understood that, in the embodiments of the present application, the flag information of the block category, the first flag information of the block category, and the second flag information of the block category are all the same, that is, single flag information (represented by cpcccmSizeId) is used, and a value of cpcccmSizeId may simultaneously indicate the reference picture index inter_pred_idc, the number of coefficients of the target filter nTap, and the shape of the target filter FilterIdx.

In the embodiments of the present application, for the value of cpcccmSizeId, it may be: decoding the bitstream to determine the value of cpcccmSizeId; or it may be: determining the value of cpcccmSizeId according to the size parameters of the current block. The size parameters of the current block may include a width (represented by nTbW) and a height (represented by nTbH).

Exemplarily, in response to that the size parameters of the current block meet that min (nTbW, nTbH)<=8, the value of cpcccmSizeId is determined to be 0; in response to that the size parameters of the current block meet that 8<min (nTbW, nTbH)<=32, the value of cpcccmSizeId is determined to be 1; or in response to that the size parameters of the current block meet that min (nTbW, nTbH)>32, the value of cpcccmSizeId is determined to be 2.

Exemplarily, in response to that the size parameters of the current block meet that min (nTbW, nTbH)<=64, the value of cpcccmSizeId is determined to be 0; in response to that the size parameters of the current block meet that 64<min (nTbW, nTbH)<=256, the value of cpcccmSizeId is determined to be 1; or in response to that the size parameters of the current block meet that min (nTbW, nTbH)>256, the value of cpcccmSizeId is determined to be 2.

S704, a reference sample value of a first color component sample of the current block is determined, and a prediction value of a second color component sample of the current block is determined according to the reference sample value of the first color component sample of the current block and the model parameters.

It should be noted that, in the embodiments of the present application, before determining the prediction value of the second color component sample of the current block, it is necessary to determine the reference sample value of the first color component sample of the current block.

In some embodiments, determining the reference sample value of the first color component sample of the current block may include: determining the reference sample value of the first color component sample of the current block according to a reconstructed value of the first color component sample of the current block.

In an embodiment, the method may further include: determining the reconstructed value of the first color component sample of the current block according to the first color component value of the first prediction block.

In the embodiments of the present application, for the uni-prediction, determining the reconstructed value of the first color component sample of the current block according to the first color component value of the first prediction block may include: determining the reconstructed value of the first color component sample of the current block according to a first color component value of a List0 prediction block of the current block; or determining the reconstructed value of the first color component sample of the current block according to a first color component value of a List1 prediction block of the current block.

In the embodiments of the present application, for the bi-prediction, determining the reconstructed value of the first color component sample of the current block according to the first color component value of the first prediction block may include: determining the reconstructed value of the first color component sample of the current block according to the first color component value of the List0 prediction block of the current block and the first color component value of the List1 prediction block of the current block.

In another embodiment, the method may further include: determining the reconstructed value of the first color component sample of the current block according to a decoding picture buffer unit (Buffer). That is, at the decoding end, the reconstructed value of the first color component sample of the current block may be directly obtained from the decoding picture buffer unit.

In some embodiments, the method may further include: performing a filtering process on the reference sample value of the first color component sample of the current block, to determine a filtering reconstructed value of the first color component sample of the current block; and determining the reference sample value of the first color component sample of the current block according to the filtering reconstructed value of the first color component sample of the current block.

It should be understood that, in the embodiments of the present application, not only the reconstructed value of the first color component sample of the current block may be used as the reference sample value of the first color component sample of the current block, but also the filtering reconstructed value of the first color component sample of the current block may be used as the reference sample value of the first color component sample of the current block, which is not specifically limited here.

In some embodiments, determining the reference sample value of the first color component sample of the current block may include: determining a prediction value of the first color component sample of the current block according to the first color component value of the first prediction block; and determining the reference sample value of the first color component sample of the current block according to the prediction value of the first color component sample of the current block.

In the embodiments of the present application, for the uni-prediction, determining the prediction value of the first color component sample of the current block according to the first color component value of the first prediction block may include: determining the prediction value of the first color component sample of the current block according to the first color component value of the List0 prediction block of the current block; or determining the prediction value of the first color component sample of the current block according to the first color component value of the List1 prediction block of the current block.

Here, taking the List0 prediction block as an example, it is specifically possible to determine the prediction value of the first color component sample of the current block according to the first color component value of the List0 prediction block of the current block, and then use the prediction value of the first color component sample of the current block as the reference sample value of the first color component sample of the current block. In addition, the processing of the List1 prediction block is similar, which will not be described in detail here.

In the embodiments of the present application, for the bi-prediction, determining the prediction value of the first color component sample of the current block according to the first color component value of the first prediction block may include: determining the prediction value of the first color component sample of the current block according to the first color component value of the List0 prediction block of the current block and the first color component value of the List1 prediction block of the current block.

In an embodiment, the method may further include: determining a List0 weighting factor of the List0 prediction block of the current block and a List1 weighting factor of the List1 prediction block of the current block; determining, according to the List0 weighting factor and the List1 weighting factor, a weighted sum of the first color component value of the List0 prediction block of the current block and the first color component value of the List1 prediction block of the current block; and determining the prediction value of the first color component sample of the current block according to the weighted sum.

Here, taking the List0 prediction block and the List1 prediction block as an example, it is specifically possible to perform weighted sum calculation on the first color component value of the List0 prediction block and the first color component value of the List1 prediction block according to the List0 weighting factor and the List1 weighting factor, to determine the prediction value of the first color component sample of the current block, and then use the prediction value of the first color component sample of the current block as the reference sample value of the first color component sample of the current block.

In some embodiments, the method may further include: performing a filtering process on the prediction value of the first color component sample of the current block, to determine a filtering prediction value of the first color component sample of the current block; and determining the reference sample value of the first color component sample of the current block according to the filtering prediction value of the first color component sample of the current block.

It should be understood that, in the embodiments of the present application, not only the prediction value of the first color component sample of the current block may be used as the reference sample value of the first color component sample of the current block, but also the filtering prediction value of the first color component sample of the current block may be used as the reference sample value of the first color component sample of the current block, which is not specifically limited here.

It should also be understood that, in the embodiments of the present application, assuming that the first color component is a luma component and the second color component is a chroma component, the filtering processing here may be low-pass filtering, or down-sampling filtering, etc., so that a resolution ratio of the first color component after filtering is the same as a resolution ratio of the second color component.

Furthermore, after the reference sample value of the first color component sample of the current block is determined, a prediction value of the second color component sample of the current block may be determined. Therefore, in some embodiments, determining the prediction value of the second color component sample of the current block according to the reference sample value of the first color component sample of the current block and the model parameters may include: determining a first input value of the target filter based on the reference sample value of the first color component sample of the current block; determining a first output value of the target filter based on the first input value and the model parameters; and determining the prediction value of the second color component sample of the current block based on the first output value.

It should be noted that, in the embodiments of the present application, after the reference sample value of the first color component sample of the current block is determined, in some embodiments, the method may further include: performing a first filtering process on the reference sample value of the first color component sample of the current block, to determine the first input value.

It should be understood that, in the embodiments of the present application, the first filtering process may include at least one of: low-pass filtering, or down-sampling filtering. Exemplarily, the down-sampling filtering may make the resolution ratio of the first color component after filtering the same as the resolution ratio of the second color component.

It should also be understood that, in the embodiments of the present application, the first filtering process sets the first input value to be equal to the reference sample value of the first color component sample of the current block.

Here, for the target filter, the reference sample value of the first color component sample of the current block may be directly used as the first input value, or a value of the first color component sample of the current block after filtering may be used as the first input value. For example, the reconstructed value of the first color component sample of the current block is used as the first input value, or the filtering reconstructed value of the first color component sample of the current block is used as the first input value, or the prediction value of the first color component sample of the current block is used as the first input value, or the filtering prediction value of the first color component sample of the current block is used as the first input value, which is not specifically limited in the embodiments of the present application.

Exemplarily, the first input value may be represented by FilterY[k][l], the model parameters may be represented by c_{i,j,k,l}, and c_{ij,k,l}=cₙ. The first output value is represented by OUT, it is specified as follows:

$$OUT = {\sum }_{k , l} FilterY [ k ] [ l ] \times {C}_{i , j , k , l} \qquad ( 20 )$$

After the first output value is determined based on the first input value and the model parameters, the first output value may be directly used as the prediction value of the second color component sample of the current block. In this case, the prediction value of the second color component sample of the current block is represented by C^{pred}[i][j], it is specified as follows:

$${C}^{pred} [ i ] [ j ] = {\sum }_{k , l} FilterY [ k ] [ l ] \times {C}_{i , j , k , l} \qquad ( 21 )$$

Here, n=0, 1, . . . , nTap−1, i=0, 1, . . . , predSizeW−1, j=0,1, . . . , predSizeH−1. In addition, a second prediction block may be determined according to the first output value, and a width of the second prediction block is predSizeW, and a height of the second prediction block is predSizeH.

It should also be noted that, in the embodiments of the present application, after determining the first output value of the target filter based on the first input value and the model parameters, if the first output value (i.e., the second prediction block) includes prediction values of all second color component samples of the current block, the first output value may be directly used as the prediction value of the second color component samples of the current block. If the first output value (i.e., the second prediction block) includes prediction values of a portion of second color component samples of the current block, it is further necessary to perform relative processing on the first output value, and the processed first output value is used as the prediction value of the second color component samples of the current block.

In some embodiments, determining the prediction value of the second color component sample of the current block based on the first output value may include: performing a second filtering process on the first output value, to determine a second output value; and determining the prediction value of the second color component sample of the current block based on the second output value.

It should be understood that, in the embodiments of the present application, the second filtering process includes at least one of: low-pass filtering, or up-sampling filtering. Exemplarily, size parameters of the second prediction block after up-sampling filtering are the same as size parameters of the current block.

It should also be understood that, in the embodiments of the present application, the second filtering process sets the second output value to be equal to the first output value.

In the embodiments of the present application, in order to limit the obtained second output value to a preset value range, it is further necessary to perform relevant processing on the second output value. In some embodiments, determining the prediction value of the second color component sample of the current block based on the second output value may include: performing a first process on the second output value, to obtain the prediction value of the second color component sample of the current block.

It should be understood that, in the embodiments of the present application, the first process is a clip operation that restricts the second output value within a preset value range.

Here, the preset value range may be 0 to (1<<BitDepth)−1, where BitDepth is a bit depth required by the chroma component. If the second output value exceeds the preset value range, a corresponding correction operation needs to be performed on the second output value. Exemplarily, the second output value may also be represented by C^{pred}[i][j], and in this case, a correction operation may be performed on C^{pred}[i][j], as follows:
in a case where the value of C^{pred}[i][j] is less than 0, it is set to 0;
in a case where the value of C^{pred}[i][j] is greater than or equal to 0 and less than or equal to (1<<BitDepth)−1, it is equal to C^{pred}[i][j]; or
in a case where the value of C^{pred}[i][j] is greater than (1<<BitDepth)−1, it is set to (1<<BitDepth)−1.

In this way, after the correction operation is performed on the second output value, it may be ensured that prediction values of all the second color component samples of the current block are between 0 and (1<<BitDepth)−1.

It should also be noted that, in the embodiments of the present application, after the first output value is determined according to the target filter, a first offset value (represented by bias) may be added to the target filter, to determine the prediction value of the second color component sample of the current block.

In some embodiments, determining the prediction value of the second color component sample of the current block based on the first output value may include: performing an additive operation according to the first output value and the first offset value, to determine the prediction value of the second color component sample of the current block.

In an embodiment, the first offset value is set to be equal to a preset constant value; or, the first offset value is set to be equal to a value of the first input value in a preset mapping relationship.

Exemplarily, it is assumed that the first color component is a luma component, the second color component is a chroma component, and the model parameters may be tap coefficients corresponding to the target filter, that is, the number of coefficients of the target filter is equal to the number of taps (nTap) of the target filter. In addition, the first offset value bias may be added to the target filter. For example, in a case where FilterIdx=1, nTap=5, and the target filter is a cross filter. In this case, the filter coefficients is the tap coefficients (c₀ to c₄) corresponding to the target filter, and the chroma prediction value obtained by calculating the (i, j) position is that:

$${C}^{pred} [ i ] [ j ] = {\sum }_{n = 0}^{4} FilterY [ k ] [ l ] \times {C}_{n} \qquad ( 22 )$$

In this case, the bias may be added, it is specified as follows:

$${C}^{pred} [ i ] [ j ] = {\sum }_{n = 0}^{4} FilterY [ k ] [ l ] \times {C}_{n} + bias \qquad ( 23 )$$

where cₙ=c_{i,j,k,l}.

It should be understood that, in the embodiments of the present application, bias may include coefficient terms involved in the calculation of the filter coefficients, e.g., bias=cₙ×Constant. Here, Constant may be a fixed constant, e.g., Constant=1<< (BitDepth−1); it may also be a value related to a co-located luma sample value at position (i, j), e.g., Constant=f(FilterY[i][j]); it may also be a value related to a luma sample value corresponding to a tap of the target filter other than the co-located luma sample value at position (i, j), e.g., Constant=f(FilterY[k][l]). Constant=f(FilterY[i][j]) or Constant=f(FilterY[k][l]) may be a linear mapping relationship or a nonlinear mapping relationship, which is not specifically limited here.

It should also be understood that, in the embodiments of the present application, bias may not include coefficient terms involved in the calculation of the filter coefficients, e.g., bias=Constant. Here, Constant may be a fixed constant, e.g., Constant=1<<(BitDepth−1); it may also be a value related to a co-located luma sample value at position (i, j), e.g., Constant=f(FilterY[i][j]); it may also be a value related to a luma sample value corresponding to a tap of the target filter other than the co-located luma position (i, j), e.g., Constant=f(FilterY[k][l]). Constant=f(FilterY[i][j]) or Constant=f(FilterY[k][l]) may be a linear mapping relationship or a nonlinear mapping relationship, which is not specifically limited here.

Furthermore, after determining the prediction value of the second color component sample of the current block C^{pred}[i][j], in some embodiments, the method may further include: performing relevant processing on the prediction value of the second color component sample of the current block, and using the processed prediction value as the prediction value of the second color component sample of the current block.

In a possible implementation, performing the relevant processing on the prediction value of the second color component sample of the current block may include: performing filtering enhancement processing on the prediction value of the second color component sample of the current block.

Exemplarily, in a case where predSizeW is not equal to the width of the current block nTbW or predSizeH is not equal to the height of the current block nTbH, it is necessary to perform an operation, such as up-sampling filtering or down-sampling filtering, to obtain a final prediction value.

Exemplarily, in order to improve the chroma prediction quality of the CP-CCCM mode, filtering enhancement may be performed on C^{pred}[i][j] as the final prediction value.

In another possible implementation, performing the relevant processing on the prediction value of the second color component sample of the current block may include: determining a compensation value of the second color component sample of the current block according to a reference sample value of a neighbouring region of the current block; and performing a correction process on the prediction value of the second color component sample of the current block according to the compensation value.

Exemplarily, in order to further improve the prediction accuracy of the CP-CCCM mode, a position-related correction process may be performed on the prediction value. For example, a chroma compensation value is calculated for each second color component sample to be predicted using a reference sample with a close spatial position, the second color component sample of the current block is corrected using the chroma compensation value, and the final prediction value of the second color component sample is determined according to the corrected prediction value.

In yet another possible implementation, performing the relevant processing on the performing prediction processing on the second color component sample of the current block according to at least one prediction mode, to determine at least one initial prediction value of the second color component sample of the current block; and performing weighted fusion processing according to the at least one initial prediction value and the prediction value of the second color component sample of the current block.

Exemplarily, in order to further improve the prediction accuracy of the CP-CCCM mode, weighted fusion may be performed on the chroma prediction value calculated by original chroma weighted prediction and the chroma prediction value calculated by the CP-CCCM mode, and the fusion result may be used as the final prediction value.

Exemplarily, in order to improve the prediction performance of the CP-CCCM mode, a neural network may be used to correct the prediction output of the CP-CCCM mode to obtain the final prediction value.

S705, a reconstructed value of the second color component sample of the current block is determined according to the prediction value of the second color component sample of the current block.

It should be noted that, in the embodiments of the present application, after the prediction value of the second color component sample of the current block is obtained, the reconstructed value of the second color component sample of the current block may also be restored. In some embodiments, determining the reconstructed value of the second color component sample of the current block according to the prediction value of the second color component sample of the current block may include:
decoding the bitstream to determine a prediction residual value (or may be referred to as prediction residual) of the second color component sample of the current block; and
determining the reconstructed value of the second color component sample of the current block according to the prediction value of the second color component sample of the current block and the prediction residual value of the second color component sample of the current block.

In an embodiment, determining the reconstructed value of the second color component sample of the current block according to the prediction value of the second color component sample of the current block and the prediction residual value of the second color component sample of the current block may include: performing an additive operation on the prediction value of the second color component sample of the current block and the prediction residual value of the second color component sample of the current block, to determine the reconstructed value of the second color component sample of the current block.

Exemplarily, taking a chroma component as an example, after obtaining the chroma prediction residual value of the current block by decoding the bitstream, the additive operation may be performed on the chroma prediction value and the chroma prediction residual value, to obtain the chroma reconstructed value of the current block.

In some embodiments, the method may further include: parsing the bitstream to determine prediction mode flag information of the current block; in a case where the prediction mode flag information indicates that a convolutional cross-component model is used for the current block to perform weighted prediction, performing the step of determining the prediction block of the current block according to motion information.

In an embodiment, the method may further include: in response to that a value of the prediction mode flag information is a fourth value, determining that the convolutional cross-component model is used for the current block to perform weighted prediction; and/or, in response to that the value of the prediction mode flag information is a fifth value, determining that the convolutional cross-component model is not used for the current block to perform weighted prediction.

It should be noted that, in the embodiments of the present application, the fourth value and the fifth value are different, and the fourth value and the fifth value may be in parameter form or in digital form. Optionally, the prediction mode flag information may be a parameter written in a profile, or may be a value of a flag, which is not specifically limited here.

Exemplarily, for the fourth value and the fifth value, the fourth value may be set to 1, and the fifth value may be set to 0; or, the fourth value may be set to true, and the fifth value may be set to false, which is not specifically limited here.

It should also be noted that, in the embodiments of the present application, the chroma prediction based on convolutional cross-component model means that the chroma prediction is performed using the CP-CCCM mode. Here, it may be determined, by certain conditions, whether the CP-CCCM mode is used for the current block for chroma prediction, to determine a final inter chroma prediction value, which are not limited to the following four manners. Exemplarily, the four manners may be as follows.

Manner 1: it is determined whether to use the CP-CCCM mode by comparing a threshold T_Distortion1 with a residual between a reconstructed luma of the first prediction block and a luma of the current block, such as SAD, MSE, SATD or SSE (or corresponding information of the luma residual of the current block).

Manner 2: on the basis of using the CP-CCCM mode in Manner 1, it is determined whether to use the chroma prediction value of the CP-CCCM mode to replace an original inter weighted chroma prediction value by comparing a threshold T_Distortion2 with a distortion between a chroma reconstructed value of the first prediction block and a chroma prediction value of the CP-CCCM mode of the first prediction block, such as SAD, MSE, SATD or SSE.

Manner 3: calculated filtering coefficients of target filter are used in a filter template of the current block to obtain a CP-CCCM prediction value of the template; a template of the first prediction block is obtained for weighted prediction to obtain a weighted template prediction value; and then the weighted template prediction value and a CP-CCCM chroma prediction value of the template are respectively calculated for distortion with respect to reconstructed chroma of the template of the current block, such as SAD, MSE, SATD or SSE, to determine whether to use the chroma prediction value of the CP-CCCM mode of the current block to replace the weighted chroma prediction value of the current block.

Manner 4: at the encoding end, a Flag may be transmitted to indicate whether to use the chroma prediction value of the CP-CCCM mode of the current block to replace the weighted chroma prediction value of the current block; so that at the decoding end, the Flag may be parsed to determine whether to use the chroma prediction value of the CP-CCCM mode of the current block to replace the weighted chroma prediction value of the current block.

The present embodiment provides a decoding method, in which, the bitstream is decoded to determine prediction parameters of the current block; the first prediction block of the current block is determine according to the prediction parameters; model parameters are determined according to the first color component value and the second color component value of the first prediction block; the reference sample value of the first color component sample of the current block is determined, and the prediction value of the second color component sample of the current block is determined according to the reference sample value of the first color component sample of the current block and the model parameters; and the reconstructed value of the second color component sample of the current block is determined according to the prediction value of the second color component sample of the current block. In this way, the model parameters determined according to the first color component value and the second color component value of the first prediction block sufficiently reflect the correlation between luma and chroma of the prediction block, and the correlation is applied to existing luma information of the current block for chroma prediction, so that the accuracy of inter chroma prediction may be improved, and the coding efficiency may be improved, thereby improving the coding performance.

In another embodiment of the present application, based on the decoding method described in the aforementioned embodiments, for determining the reference sample value of the first color component sample of the current block, in addition to being determined according to the reconstructed value of the first color component sample of the current block or according to the prediction value of the first color component sample of the current block, it may also be determined according to the prediction residual value of the first color component sample of the current block. In this case, for the model parameters, the model parameters may be determined by a first color component residual value and a second color component residual value of the first prediction block, adaptively.

In some embodiments, the method may further include: determining the prediction residual value of the first color component sample of the current block; determining the reference sample value of the first color component sample of the current block according to the prediction residual value of the first color component sample of the current block; determining the first color component residual value and the second color component residual value of the first prediction block; and determining the model parameters according to the first color component residual value and the second color component residual value of the first prediction block.

Accordingly, in some embodiments, determining the prediction value of the second color component sample of the current block according to the reference sample value of the first color component sample of the current block and the model parameters may include: determining an initial prediction residual value of the second color component sample of the current block according to the prediction residual value of the first color component sample of the current block and the model parameters; determining an initial prediction value of the second color component sample of the current block according to the first prediction block; determining the prediction value of the second color component sample of the current block according to the initial prediction residual value and the initial prediction value of the second color component sample of the current block.

Optionally, taking the first color component as a luma component and the second color component as a chroma component as an example, the model parameters are determined according to a luma residual value and a chroma residual value of the first prediction block, and the model parameters may reflect a correspondence between the luma residual and the chroma residual. Then, after determining the luma prediction residual value of the current block, the initial chroma prediction residual value of the current block may be determined according to the model parameters and the luma prediction residual value of the current block; then, inter prediction processing is performed according to the first prediction block to determine the initial chroma prediction value of the current block; an additive operation is performed on the initial chroma prediction value of the current block and the initial chroma prediction residual value of the current block, to obtain the final chroma prediction value of the current block.

It should be understood that, in the embodiments of the present application, for the first color component residual value and the second color component residual value of the first prediction block, an additional decoding buffer unit is also required here, to buffer the luma residual value and the chroma residual value of the first prediction block.

It should also be understood that, in the embodiments of the present application, in a case of determining the model parameters, not only the first color component value and the second color component value of the first prediction block may be used, but also the first color component residual value and the second color component residual value of the first prediction block, as well as the first color component residual value after filtering and the second color component residual value after filtering of the first prediction block, or even the first color component residual value and the second color component value of the first prediction block, etc., which is not specifically limited here.

In an embodiment, referring to FIG. 8, a schematic flow block diagram of a decoding method provided by the embodiments of the present application is illustrated. As shown in FIG. 8, the flowchart may include a model parameter generating unit 801, a target filter 802, and a post-processing unit 803. For the model parameter generating unit 801, the input is input information, and the output is the model parameters. For the target filter 802, the model parameters are filtering parameters of the target filter 802, the input is a model input value, and the output is a model output value. If the post-processing unit 803 does not exist, the model output value is the chroma prediction value; if the post-processing unit 803 exists, it is necessary to perform relevant processing on the model output value to obtain the chroma prediction value.

It should be noted that, in the embodiments of the present application, the first prediction block is a matching block of the reference picture, which may be represented by pic (xCb−mvX, yCb−mvY, t−refIdxLX); the current block is a block to be decoded of the current picture, which may be represented by pic (xCb, yCb, t); where mvX indicates a motion vector of an x-axis, mvY indicates a motion vector of a y-axis, and refIdxLX indicates time domain information between the current picture and the reference picture.

It should also be noted that, in the embodiments of the present application, for the cross-component prediction of the current block, the reconstructed sample information of the first prediction block is not directly used as the chroma prediction value of the current block, the reconstructed sample information of the first prediction block is used as auxiliary information for chroma prediction to determine the chroma prediction value of the current block.

As for the input information, the input information may be luma reconstructed information and chroma reconstructed information of the first prediction block, or may be luma reconstructed information after filtering and/or chroma reconstructed information after filtering of the first prediction block. In addition, the input information may also be luma reconstructed residual information and chroma reconstructed residual information of the first prediction block, or luma reconstructed residual information after filtering and/or chroma reconstructed residual information after filtering of the first prediction block. In addition, the input information may also be the luma reconstructed residual information and the chroma reconstructed information of the first prediction block, or the luma reconstructed residual information after filtering and/or the chroma reconstructed information after filtering of the first prediction block, which is not specifically limited in the embodiments of the present application. It should also be noted that the additional decoding buffer units are required to buffer both the luma reconstruction residual information and the chroma reconstruction residual information of the first prediction block.

As for the model input value, the model input value is the reference sample value of the first color component sample of the current block in the aforementioned embodiments. The model input value may be the luma component value of the first prediction block or the luma component value after filtering of the first prediction block. In this case, in a case where the post-processing unit 803 does not exist, the model output value is the chroma prediction value of the current block; or in a case where the post-processing unit 803 exists, the model output value is the initial chroma prediction value of the current block, and then the initial chroma prediction value is subjected to the relevant processing (such as clip operation) to obtain the chroma prediction value of the current block.

In addition, the model input value may also be the luma reconstructed value of the current block or the luma reconstructed value after filtering of the current block. In this case, in a case where the post-processing unit 803 does not exist, the model output value is the chroma prediction value of the current block; or in a case where the post-processing unit 803 exists, the model output value is the initial chroma prediction value of the current block, and then the initial chroma prediction value is subjected to the relevant processing (such as clip operation) to obtain the chroma prediction value of the current block.

In addition, the model input value may also be the luma prediction residual value of the current block or the luma prediction residual value after filtering of the current block. In this case, in a case where the post-processing unit 803 does not exist, the model output value is the chroma prediction value of the current block; or in a case where the post-processing unit 803 exists, the model output value is the initial chroma prediction value of the current block, and then the initial chroma prediction value is subjected to the relevant processing (such as clip operation) to obtain the chroma prediction value of the current block; or in a case where the post-processing unit 803 exists, the model output value may also be an initial chroma prediction residual pred ResidualChroma (xCb, yCb) of the current block, then the chroma prediction value of the current block is determined according to the initial chroma prediction value determined by the first prediction block and the initial chroma prediction residual, and in this case, the chroma reconstructed value may be obtained according to the initial chroma prediction value determined by the first prediction block and the initial chroma prediction residual, and the chroma prediction residual of decoding bitstream; or in a case where the post-processing unit 803 exists, the model output value may also be the initial chroma prediction residual predResidualChroma (xCb, yCb) of the current block, then the chroma prediction value of the current block is determined according to the initial chroma prediction value determined by the first prediction block and the initial chroma prediction residual after filtering, in this case, the chroma reconstructed value may be obtained according to the initial chroma prediction value determined by the first prediction block and the initial chroma prediction residual after filtering and the chroma prediction residual of decoding bitstream.

It should also be noted that, the chroma prediction method in the embodiments of the present application is generally not applicable to the uni-prediction (including forward prediction or backward prediction). For the uni-prediction, the reconstructed chroma information of the first prediction block may be directly used for chroma prediction.

The present embodiment provides a decoding method. Through the implementations of the above embodiments, it may be seen that the model parameters determined according to the first color component value and the second color component value of the first prediction block sufficiently reflect the correlation between luma and chroma of the prediction block, and the correlation is applied to the existing luma information of the current block for chroma prediction, so that the accuracy of inter chroma prediction may be improved, and the coding efficiency may be improved, thereby improving the coding performance.

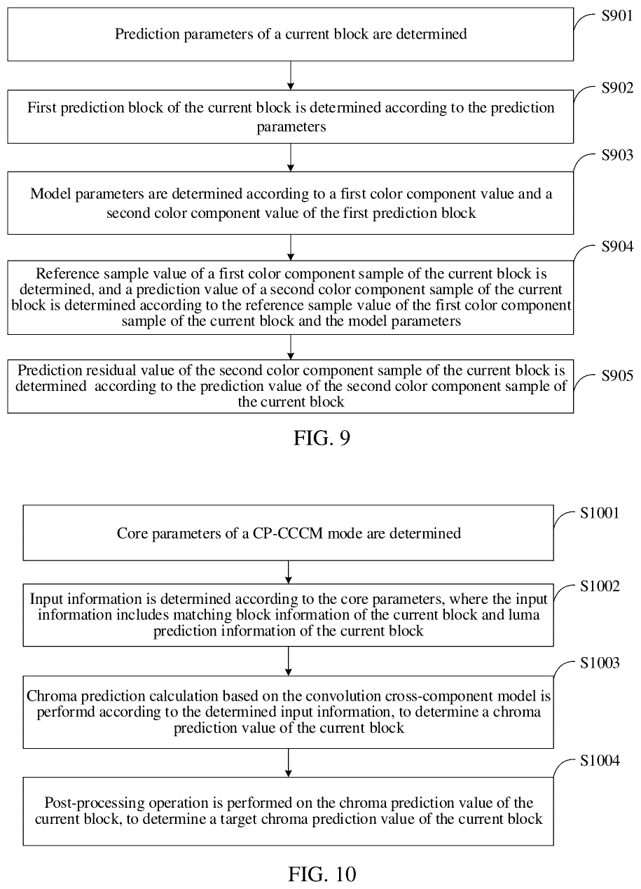

In yet another embodiment of the present application, referring to FIG. 9, a schematic flowchart of an encoding method provided by the embodiments of the present application is illustrated. As shown in FIG. 9, the method may include following contents.

S901, prediction parameters of a current block are determined.

It should be noted that the encoding method in the embodiments of the present application is applied to an encoder. In addition, the encoding method may specifically refer to an inter prediction method, and more specifically, an inter chroma prediction method. In a inter prediction process, CP-CCCM-based technology is proposed here, which is capable of improving the accuracy of chroma prediction.

In the embodiments of the present application, a video picture may be partitioned into multiple encoding blocks, each encoding block may include a first color component, a second color component and a third color component, and the current block in the embodiments of the present application refers to an encoding block of the video picture on which inter prediction to be performed currently.

It should also be noted that, in the embodiments of the present application, the prediction parameters of the current block need to be determined first. In some embodiments, the prediction parameters may include: a motion vector, a reference picture index, and an inter prediction flag parameter.

The reference picture index indicates whether the reference picture used by the current block is List0 or List1; the inter prediction flag parameter indicates a prediction mode used for encoding the current block, and the prediction mode may include List0 prediction, List1 prediction, and bi-prediction.

It should be understood that, in the embodiments of the present application, List0 indicates (specifies) reference picture list 0, which may also be called a forward reference picture; List1 (specifies) indicates reference picture list 1, which may also be called a backward reference picture.

It should also be understood that, in the embodiments of the present application, the inter prediction flag parameter indicates that the prediction mode used for encode the current block is the bi-prediction.

Exemplarily, if the bi-prediction is used for the current block, the inter prediction flag parameter may indicate that the prediction mode used for encoding the current block is the bi-prediction. Otherwise, if the List0 prediction or List1 prediction is used for the current block, the inter prediction flag parameter may indicate that the prediction mode used for encoding the current block is the uni-prediction. The prediction mode used for the current block is set according to actual conditions, which is not limited in the embodiments of the present application.

Exemplarily, the reference picture index may be represented by inter_pred_idc, and the prediction list usage flag information may be represented by predFlagLX. If X equals to 0 (X=0), i.e., predFlagL0 equals to 0 (predFlagL0=1), the reference picture List0 may be used for the uni-prediction; if X equals to 1 (X=1), i.e., predFlagL1 equals to 1 (predFlagL1=1), the reference picture List1 may be used for the uni-prediction; if predFlagL0=1 and predFlagL1=1, the reference picture List0 and reference picture List1 may be used for the bi-prediction.

In some embodiments, the method may further include: encoding the prediction parameters, and writing the obtained encoded bits into a bitstream.

It should be understood that, in the embodiments of the present application, an encoding end may encode the prediction parameters into the bitstream, which is then transmitted to a decoding end. In this way, at the decoding end, the prediction parameters, such as a motion vector, a reference picture index, an inter prediction flag parameter, may be obtained by decoding the bitstream.

S902, a first prediction block of the current block is determined according to the prediction parameters.

In the embodiments of the present application, the first prediction block of the current block, such as a List0 prediction block and a List1 prediction block, may be determined according to the obtained motion vector, the reference picture index, inter prediction flag parameter or other information. Therefore, in some embodiments, the method may further include: determining a List0 prediction block of the current block, a List1 prediction block of the current block according to the prediction parameters.

In an embodiment, the first prediction block is the List0 prediction block of the current block; or, the first prediction block is the List1 prediction block of the current block; or, the first prediction blocks includes the List0 prediction block of the current block and the List1 prediction block of the current block.

It should be noted that, for the uni-prediction, the first prediction block may be the List0 prediction block of the current block, i.e., the forward matching block; or, the first prediction block may be the List1 prediction block of the current block, i.e., the backward matching block.

It should also be noted that, for the bi-prediction, the first prediction block may include the List prediction block of the current block and the List1 prediction block of the current block. In this case, a prediction value of the bi-prediction is equal to a sum of the product of w0 and predList0 and the product of w1 and predList1 (i.e., predBI=w0×predList0+w1×predList1), where w0 and w1 indicate weighted values.

In a possible implementation, in a case where the prediction parameters include the motion vector, the first prediction block of the current block may be determined according to the motion vector. In a case where the prediction parameters include a first motion vector (e.g., a forward motion vector), the List0 prediction block of the current block may be determined according to the first motion vector; and/or, in a case where the prediction parameters include a second motion vector (e.g., a backward motion vector), the List1 prediction block of the current block may be determined according to the second motion vector.

In another possible implementation, in a case where the prediction parameters include the reference picture index, the first prediction block of the current block may also be determined according to the value of the reference picture index. In response to that the value of the reference picture index is a first value, it is determined that the first prediction block is the List0 prediction block of the current block; or, in response to that the value of the reference picture index is a second value, it is determined that the first prediction block is the List1 prediction block of the current block; or, in response to that the value of the reference picture index is a third value, it is determined that the first prediction block includes the List0 prediction block of the current block and the List1 prediction block of the current block.

Exemplarily, the reference picture index may be represented by inter_pred_idc. Assuming that the first value, the second value and the third value are set to 0, 1, and 2 respectively, in a case where a value of inter_pred_idc is 0, the first prediction block may be the List0 prediction block; in a case where the value of inter_pred_idc is 1, the first prediction block may be the List1 prediction block; in a case where the value of inter_pred_idc is 2, the first prediction block includes the List0 prediction block and the List1 prediction block.

Furthermore, in the embodiments of the present application, the value of the reference picture index may be determined according to flag information of a block category of the current block, and the flag information of the block category of the current block is associated with size parameters of the current block. In some embodiments, the method may further include: determining the flag information of the block category of the current block according to the size parameters of the current block; encoding the flag information of the block category of the current block, and writing the obtained encoded bits into the bitstream.

In this way, the encoding end may encode the flag information of the block category of the current block into the bitstream, which is then transmitted to the decoding end. In this way, at the decoding end, the flag information of the block category of the current block may be obtained by decoding the bitstream, and then the value of inter_pred_idc may be determined according to the flag information of the block category of the current block, so that the first prediction block may be determined.

S903, model parameters are determined according to a first color component value and a second color component value of the first prediction block.

In the embodiments of the present application, after determining the first prediction block of the current block, the first color component value and the second color component value of the first prediction block may be obtained. The first color component value and the second color component value are both reconstructed information. The model parameters may be calculated according to the first color component value and the second color component value of the first prediction block.

In the embodiments of the present application, the model parameters are determined according to the first color component value and the second color component value of the first prediction block, and the model parameters here may include coefficients of a target filter. Therefore, in some embodiments, the method may include: determining the coefficients of the target filter according to the first color component value and the second color component value of the first prediction block.

In an embodiment, the coefficients of the target filter may be determined by solving the optimization problem. Accordingly, the method may further include that the coefficients of the target filter are coefficients used by the target filter in a case where a first error between an output value of the second color component value of the first prediction block processed by the target filter and an output value of the first color component value of the first prediction block processed by the target filter meets a first condition.

It should be understood that, for the first error to meet the first condition, in a possible implementation, the first condition is that the first error is minimum. Alternatively, in another possible implementation, the first condition is that the first error is within a first preset threshold range. Alternatively, in yet another possible implementation, the first condition is that a variation of the first error is within a second preset threshold range.

In another embodiment, determining the coefficients of the target filter according to the first color component value and the second color component value of the first prediction block may include: determining autocorrelation parameters according to the first color component value of the first prediction block; determining cross-correlation parameters according to the first color component value and the second color component value of the first prediction block; and determining the coefficients of the target filter according to the autocorrelation parameters and the cross-correlation parameters.

In this way, according to the determined first prediction block (reference block region), by solving the system of linear equations shown in the aforementioned formula (18), a set of coefficients of target filter may be obtained, such that the MSE between the expected output after filtering, i.e., the chroma value predicted by CP-CCCM and the chroma reconstructed value of the expected output is minimum, i.e., the Wiener filtering coefficients, which are a set of coefficients of the target filter for the current block.

In the process of solving the system of linear equations, the autocorrelation parameters of the luma reconstructed samples refRecY of the first prediction block are first calculated, and then the cross-correlation parameters of the luma reconstructed samples refRecY and the chroma reconstruction samples refRecC of the first prediction block are calculated. Then, the autocorrelation parameters are subjected to Cholesky decomposition or LDL decomposition, and finally, each target filter coefficient cₙ is calculated in sequence by reverse recursion.

In the embodiments of the present application, for the target filter, it is further necessary to determine the number of coefficients of the target filter and the shape of the target filter. The number of coefficients of the target filter and the shape of the target filter may be preset fixed values, or may be associated with size parameters of the current block.

In some embodiments, for the number of coefficients of the target filter, the method may further include: determining the number of coefficients of the target filter.

In the embodiments of the present application, the number of coefficients of the target filter may be equal to a first preset constant value.

In some embodiments, the method may further include: determining first flag information of a block category of the current block; and determining the number of coefficients of the target filter according to the first flag information of the block category of the current block.

In some embodiments, the method may further include: encoding the number of coefficients of the target filter, and writing the obtained coded bits into the bitstream. Alternatively, in some embodiments, the method may further include: encoding the first flag information of the block category of the current block, and writing the obtained encoded bits into the bitstream.

It should be noted that the number of coefficients of the target filter may be represented by nTap. Exemplarily, a value of nTap may be 4, 5, 6, 7, 8, 9, etc., which is not specifically limited thereto.

It should also be noted that the number of coefficients of the target filter may also be called the number of taps of the target filter. Here, the number of coefficients of the target filter may be a preset constant value, or may be determined according to the first flag information of the block category of the current block, which is not specifically limited thereto.

In some embodiments, for the shape of the target filter, the method may further include: determining the shape of the target filter.

In the embodiments of the present application, the target filter may be a one-dimensional or two-dimensional filter with a preset shape.

In some embodiments, the method may further include: determining a value of a filter shape parameter, where the filter shape parameter indicates the shape of the target filter.

In some embodiments, for the shape of the target filter, the method may further include: determining second flag information of the block category of the current block; and determining the value of the filter shape parameter according to the second flag information of the block category of the current block.

In some embodiments, the method further includes: encoding the shape of the target filter, and writing the obtained encoded bits into the bitstream. Alternatively, in some embodiments, the method further includes: encoding the value of the filter shape parameter, and writing the obtained encoded bits into the bitstream. Alternatively, in some embodiments, the method further includes: encoding the second flag information of the block category of the current block, and writing the obtained encoded bits into the bitstream.

It should be noted that the filter shape parameter may be represented by FilterIdx, and FilterIdx is used to indicate the shape of the target filter. Exemplarily, the shape of the target filter may be a diamond, a rectangle, a cross, a stripe, or even a one-dimensional filter, a two-dimensional filter, which is not specifically limited thereto.

Exemplarily, in response to that a value of FilterIdx is equal to 0, the shape of the target filter is determined to be a diamond; in response to that the value of FilterIdx is equal to 1, the shape of the target filter is determined to be a cross; in response to that the value of FilterIdx is equal to 2, the shape of the target filter is determined to be a rectangle.

It should also be noted that the shape of the target filter may be a preset shape, or may be determined according to the second flag information of the block category of the current block, which is not specifically limited here.

It should be understood that, in the embodiments of the present application, the second flag information of the block category may be the same as or different from the first flag information of the block category. Exemplarily, in an embodiment, the first flag information of the block category is the same as the second flag information of the block category, that is, single flag information may be used to indicate both the number of coefficients of the target filter and the shape of the target filter.

It should also be understood that, in the embodiments of the present application, the flag information of the block category, the first flag information of the block category, and the second flag information of the block category are all the same, that is, single flag information (represented by cpcccmSizeId) is used, and a value of cpcccmSizeId may simultaneously indicate the reference picture index inter_pred_idc, the number of coefficients of the target filter nTap, and the shape of the target filter FilterIdx.

In the embodiments of the present application, for the value of cpcccmSizeId, it may be: determining the value of cpcccmSizeId according to the size parameters of the current block. The size parameters of the current block may include a width (represented by nTbW) and a height (represented by nTbH).

Exemplarily, in response to that the size parameters of the current block meet that min (nTbW, nTbH)<=8, the value of cpcccmSizeId is determined to be 0; in response to that the size parameters of the current block meet that 8<min (nTbW, nTbH)<=32, the value of cpcccmSizeId is determined to be 1; or in response to that the size parameters of the current block meet that min (nTbW, nTbH)>32, the value of cpcccmSizeId is determined to be 2.

Exemplarily, in response to that the size parameters of the current block meet that min (nTbW, nTbH)<=64, the value of cpcccmSizeId is determined to be 0; in response to that the size parameters of the current block meet that 64<min (nTbW, nTbH)<=256, the value of cpcccmSizeId is determined to be 1; or in response to that the size parameters of the current block meet that min (nTbW, nTbH)>256, the value of cpcccmSizeId is determined to be 2.

In some embodiments, in order to speed up the processing speed of the decoding end, the method may further include: encoding the value of cpcccmSizeId, and writing the obtained encoded bits into the bitstream. In this way, after the bitstream is transmitted from the encoding end to the decoding end, the decoding end may directly determine the value of cpcccmSizeId by decoding the bitstream subsequently, and then determine the number of coefficients of the target filter and the shape of the target filter, so as to construct the target filter.

S904, a reference sample value of a first color component sample of the current block is determined, and a prediction value of a second color component sample of the current block is determined according to the reference sample value of the first color component sample of the current block and the model parameters.

It should be noted that, in the embodiments of the present application, before determining the prediction value of the second color component sample of the current block, it is necessary to determine the reference sample value of the first color component sample of the current block.

In some embodiments, determining the reference sample value of the first color component sample of the current block may include: determining the reference sample value of the first color component sample of the current block according to a reconstructed value of the first color component sample of the current block.

In an embodiment, the method may further include: determining the reconstructed value of the first color component sample of the current block according to the first color component value of the first prediction block.

In the embodiments of the present application, for the uni-prediction, determining the reconstructed value of the first color component sample of the current block according to the first color component value of the first prediction block may include: determining the reconstructed value of the first color component sample of the current block according to a first color component value of a List0 prediction block of the current block; or determining the reconstructed value of the first color component sample of the current block according to a first color component value of the List1 prediction block of the current block.

Here, for the reconstructed value of the first color component sample of the current block, taking the List0 prediction block as an example, it is specifically possible to determine the prediction value of the first color component sample of the current block according to the first color component value of the List0 prediction block of the current block; determine a prediction residual of the first color component sample of the current block according to an original value and the prediction value of the first color component sample of the current block; perform quantization and inverse quantization processing on the prediction residual value of the first color component sample of the current block, to determine a reconstructed residual value of the first color component sample of the current block; and determine the reconstructed value of the first color component sample of the current block according to the reconstructed residual value and the prediction value of the first color component sample of the current block.

In the embodiments of the present application, for the bi-prediction, determining the reconstructed value of the first color component sample of the current block according to the first color component value of the first prediction block may include: determining the reconstructed value of the first color component sample of the current block according to the first color component value of the List0 prediction block of the current block and the first color component value of the List1 prediction block of the current block.

Here, for the reconstructed value of the first color component sample of the current block, taking the List0 prediction block and the List1 prediction block as examples, it is specifically possible to perform weighted sum calculation on the first color component value of the List0 prediction block and the first color component value of the List1 prediction block according to the List0 weighting factor and the List1 weighting factor, to determine the prediction value of the first color component sample of the current block; according to the original value and the prediction value of the first color component sample of the current block, determine the prediction residual value of the first color component sample of the current block; perform quantization and inverse quantization processing on the predicted residual value of the first color component sample of the current block, to determine the reconstructed residual value of the first color component sample of the current block; and determine the reconstructed value of the first color component sample of the current block according to the reconstructed residual and the prediction value of the first color component sample of the current block.

In this way, in the embodiments of the present application, after the reconstructed value of the first color component sample of the current block is determined, it is further necessary to store it in a decoding picture buffer unit (Buffer). Thus, at the decoding end, the reconstructed value of the first color component sample of the current block may be directly obtained from the decoding picture buffer unit.

In some embodiments, the method may further include: performing a filtering process on the reference sample value of the first color component sample of the current block, to determine a filtering reconstructed value of the first color component sample of the current block; and determining the reference sample value of the first color component sample of the current block according to the filtering reconstructed value of the first color component sample of the current block.

It should be understood that, in the embodiments of the present application, not only the reconstructed value of the first color component sample of the current block may be used as the reference sample value of the first color component sample of the current block, but also the filtering reconstructed value of the first color component sample of the current block may be used as the reference sample value of the first color component sample of the current block, which is not specifically limited here.

In some embodiments, determining the reference sample value of the first color component sample of the current block may include: determining a prediction value of the first color component sample of the current block according to the first color component value of the first prediction block; and determining the reference sample value of the first color component sample of the current block according to the prediction value of the first color component sample of the current block.

In the embodiments of the present application, for the uni-prediction, determining the prediction value of the first color component sample of the current block according to the first color component value of the first prediction block may include: determining the prediction value of the first color component sample of the current block according to the first color component value of the List0 prediction block of the current block; or determining the prediction value of the first color component sample of the current block according to the first color component value of the List1 prediction block of the current block.

In the embodiments of the present application, for the bi-prediction, determining the prediction value of the first color component sample of the current block according to the first color component value of the first prediction block may include: determining the prediction value of the first color component sample of the current block according to the first color component value of the List0 prediction block of the current block and the first color component value of the List1 prediction block of the current block.

In an embodiment, the method may further include: determining a List0 weighting factor of the List0 prediction block of the current block and a List1 weighting factor of the List1 prediction block of the current block; determining, according to the List0 weighting factor and the List1 weighting factor, a weighted sum of the first color component value of the List0 prediction block of the current block and the first color component value of the List1 prediction block of the current block; and determining the prediction value of the first color component sample of the current block according to the weighted sum.

Here, taking the List0 prediction block and the List1 prediction block as an example, it is specifically possible to perform weighted sum calculation on the first color component value of the List0 prediction block and the first color component value of the List1 prediction block according to the List0 weighting factor and the List1 weighting factor, to determine the prediction value of the first color component sample of the current block, and then use the prediction value of the first color component sample of the current block as the reference sample value of the first color component sample of the current block.

In some embodiments, the method may further include: performing a filtering process on the prediction value of the first color component sample of the current block, to determine a filtering prediction value of the first color component sample of the current block; and determining the reference sample value of the first color component sample of the current block according to the filtering prediction value of the first color component sample of the current block.

It should be understood that, in the embodiments of the present application, not only the prediction value of the first color component sample of the current block may be used as the reference sample value of the first color component sample of the current block, but also the filtering prediction value of the first color component sample of the current block may be used as the reference sample value of the first color component sample of the current block, which is not specifically limited here.

It should also be understood that, in the embodiments of the present application, assuming that the first color component is a luma component and the second color component is a chroma component, the filtering processing here may be low-pass filtering, or down-sampling filtering, etc., so that a resolution ratio of the first color component after filtering is the same as a resolution ratio of the second color component.

Furthermore, after the reference sample value of the first color component sample of the current block is determined, a prediction value of the second color component sample of the current block may be determined. Therefore, in some embodiments, determining the prediction value of the second color component sample of the current block according to the reference sample value of the first color component sample of the current block and the model parameters may include: determining a first input value of the target filter based on the reference sample value of the first color component sample of the current block; determining a first output value of the target filter based on the first input value and the model parameters; and determining the prediction value of the second color component sample of the current block based on the first output value.

It should be noted that, in the embodiments of the present application, after the reference sample value of the first color component sample of the current block is determined, in some embodiments, the method may further include: performing a first filtering process on the reference sample value of the first color component sample of the current block, to determine the first input value.

It should be understood that, in the embodiments of the present application, the first filtering process may include at least one of: low-pass filtering, or down-sampling filtering.

It should also be understood that, in the embodiments of the present application, the first filtering process sets the first input value to be equal to the reference sample value of the first color component sample of the current block.

Here, for the target filter, the reference sample value of the first color component sample of the current block may be directly used as the first input value, or a value of the first color component sample of the current block after filtering may be used as the first input value. For example, the reconstructed value of the first color component sample of the current block is used as the first input value, or the filtering reconstructed value of the first color component sample of the current block is used as the first input value, or the prediction value of the first color component sample of the current block is used as the first input value, or the filtering prediction value of the first color component sample of the current block is used as the first input value, which is not specifically limited in the embodiments of the present application.

It should also be noted that, in the embodiments of the present application, after determining the first output value of the target filter based on the first input value and the model parameters, if the first output value includes prediction values of all second color component samples of the current block, the first output value may be directly used as the prediction value of the second color component samples of the current block. If the first output value includes prediction values of a portion of second color component samples of the current block, it is further necessary to perform relative processing on the first output value, and the processed first output value is used as the prediction value of the second color component samples of the current block.

In some embodiments, determining the prediction value of the second color component sample of the current block based on the first output value may include: performing a second filtering process on the first output value, to determine a second output value; and determining the prediction value of the second color component sample of the current block based on the second output value.

It should be understood that, in the embodiments of the present application, the second filtering process includes at least one of: low-pass filtering, or up-sampling filtering.

It should also be understood that, in the embodiments of the present application, the second filtering process sets the second output value to be equal to the first output value.

In the embodiments of the present application, in order to limit the obtained second output value to a preset value range, it is further necessary to perform relevant processing on the second output value. In some embodiments, determining the prediction value of the second color component sample of the current block based on the second output value may include: performing a first process on the second output value, to obtain the prediction value of the second color component sample of the current block.

It should be understood that, in the embodiments of the present application, the first process is a clip operation that restricts the second output value within a preset value range.

Here, the preset value range may be 0 to (1<<BitDepth)−1, where BitDepth is a bit depth required by the chroma component. If the second output value exceeds the preset value range, a corresponding correction operation needs to be performed on the second output value. Exemplarily, the second output value may also be represented by C^{pred}[i][j], and in this case, a correction operation may be performed on C^{pred}[i][j], to ensure that prediction values of all second color component samples of the current block are between 0 and (1<<BitDepth)−1.

It should also be noted that, in the embodiments of the present application, after the first output value is determined according to the target filter, a first offset value (represented by bias) may be added to the target filter, to determine the prediction value of the second color component sample of the current block.

In some embodiments, determining the prediction value of the second color component sample of the current block based on the first output value may include: performing an additive operation according to the first output value and the first offset value, to determine the prediction value of the second color component sample of the current block.

In an embodiment, the first offset value is set to be equal to a preset constant value; or, the first offset value is set to be equal to a value of the first input value in a preset mapping relationship.

Exemplarily, it is assumed that the first color component is a luma component, the second color component is a chroma component, and the model parameters may be tap coefficients corresponding to the target filter, that is, the number of coefficients of the target filter is equal to the number of taps (nTap) of the target filter. In addition, the first offset value bias may be added to the target filter. For example, in a case where FilterIdx=1, nTap=5, and the target filter is a cross filter. In this case, the filter coefficients is the tap coefficients (c₀ to c₄) corresponding to the target filter, and the chroma prediction value obtained by calculating the (i, j) position is as shown in the aforementioned formula (22). In this case, the bias may be added, as shown in the aforementioned formula (23).

It should be understood that, in the embodiments of the present application, bias may include coefficient terms involved in the calculation of the filter coefficients, for example, bias=Cₙ×Constant. Here, Constant may be a fixed constant, for example, Constant=1<< (BitDepth−1); it may also be a value related to a co-located luma sample value at position (i, j), for example, Constant=f(FilterY[i][j]); it may also be a value related to a luma sample value corresponding to a tap of the target filter other than the co-located luma sample value at position (i, j), for example, Constant=f(FilterY[k][l]). Constant=f(FilterY[i][j]) or Constant=f(FilterY[k][l]) may be a linear mapping relationship or a nonlinear mapping relationship, which is not specifically limited here.

It should also be understood that, in the embodiments of the present application, bias may not include coefficient terms involved in the calculation of the filter coefficients, for example, bias=Constant. Here, Constant may be a fixed constant, for example, Constant=1<<(BitDepth−1); it may also be a value related to a co-located luma sample value at position (i, j), for example, Constant=f(FilterY[i][j]); it may also be a value related to a luma sample value corresponding to a tap of the target filter other than the co-located luma position (i, j), for example, Constant=f(FilterY[k][l]). Constant=f(FilterY[i][j]) or Constant=f(FilterY[k][l]) may be a linear mapping relationship or a nonlinear mapping relationship, which is not specifically limited here.

Furthermore, after determining the prediction value of the second color component sample of the current block C^{pred}[i][j], in some embodiments, the method may further include: performing relevant processing on the prediction value of the second color component sample of the current block, and using the processed prediction value as the prediction value of the second color component sample of the current block.

In a possible implementation, performing the relevant processing on the prediction value of the second color component sample of the current block may include: performing filtering enhancement processing on the prediction value of the second color component sample of the current block.

In another possible implementation, performing the relevant processing on the determining a compensation value of the second color component sample of the current block according to a reference sample value of a neighbouring region of the current block; and performing a correction process on the prediction value of the second color component sample of the current block according to the compensation value.

In yet another possible implementation, performing the relevant processing on the prediction value of the second color component sample of the current block may include: performing prediction processing on the second color component sample of the current block according to at least one prediction mode, to determine at least one initial prediction value of the second color component sample of the current block; and performing weighted fusion processing according to the at least one initial prediction value and the prediction value of the second color component sample of the current block.

In addition, in order to improve the prediction performance of the CP-CCCM mode, the relevant processing is performed on the prediction value of the second color component sample of the current block, and neural network may be used to correct the prediction output of the CP-CCCM mode to obtain the final prediction value.

It may also be understood that, in the embodiments of the present application, for determining the reference sample value of the first color component sample of the current block, in addition to being determined according to the reconstructed value of the first color component sample of the current block or according to the prediction value of the first color component sample of the current block, it may also be determined according to the prediction residual value of the first color component sample of the current block. In this case, for the model parameters, the model parameters may be determined by a first color component residual value and a second color component residual value of the first prediction block, adaptively.

In some embodiments, the method may further include: determining the prediction residual value of the first color component sample of the current block; determining the reference sample value of the first color component sample of the current block according to the prediction residual value of the first color component sample of the current block; determining the first color component residual value and the second color component residual value of the first prediction block; and determining the model parameters according to the first color component residual value and the second color component residual value of the first prediction block.

Accordingly, in some embodiments, determining the prediction value of the second color component sample of the current block according to the reference sample value of the first color component sample of the current block and the model parameters may include: determining an initial prediction residual value of the second color component sample of the current block according to the prediction residual value of the first color component sample of the current block and the model parameters; determining an initial prediction value of the second color component sample of the current block according to the first prediction block; determining the prediction value of the second color component sample of the current block according to the initial prediction residual value and the initial prediction value of the second color component sample of the current block.

It should be understood that, in the embodiments of the present application, for the first color component residual value and the second color component residual value of the first prediction block, an additional decoding buffer unit is required here, to buffer the luma residual value and the chroma residual value of the first prediction block.

It should also be understood that, in the embodiments of the present application, in a case of determining the model parameters, not only the first color component value and the second color component value of the first prediction block may be used, but also the first color component residual value and the second color component residual value of the first prediction block, as well as the first color component residual value after filtering and the second color component residual value after filtering of the first prediction block, or even the first color component residual value and the second color component value of the first prediction block, etc., which is not specifically limited here.

S905, a prediction residual value of the second color component sample of the current block is determined according to the prediction value of the second color component sample of the current block.

It should be noted that, in the embodiments of the present application, after obtaining the prediction value of the second color component sample of the current block, the prediction residual value of the second color component sample of the current block may further be calculated. In some embodiments, determining the prediction residual value of the second color component sample of the current block according to the prediction value of the second color component sample of the current block may include: determining the initial value of the second color component sample of the current block; and determining the prediction residual value of the second color component sample of the current block according to the initial value of the second color component sample of the current block and the prediction value of the second color component sample of the current block.

In an embodiment, determining the prediction residual value of the second color component sample of the current block according to the initial value of the second color component sample of the current block and the prediction value of the second color component sample of the current block may include: performing a subtraction operation on the initial value of the second color component sample of the current block and the prediction value of the second color component sample of the current block, to determine the prediction residual value of the second color component sample of the current block.

Furthermore, in some embodiments, the method may further include: encoding the prediction residual value of the second color component sample of the current block, and writing the obtained encoded bits into the bitstream.

In this way, the encoding end may encode the prediction residual value of the second color component sample of the current block into the bitstream, which is transmitted to the decoding end. Thus, at the decoding end, the prediction residual value of the second color component sample of the current block may be obtained by decoding the bitstream, and then the reconstructed value of the second color component sample of the current block may be restored.

In some embodiments, the method may further include: determining prediction mode flag information of the current block; in a case where the prediction mode flag information indicates that the convolutional cross-component model is used for the current block to perform weighted prediction, performing the step of determining the prediction block of the current block according to motion information.

In an embodiment, the method may further include:
in response to that the convolutional cross-component model is used for the current block to perform weighted prediction, determining that a value of the prediction mode flag information is a fourth value; or
in response to that it is determined that the convolution cross-component model is not used for the current block to perform weighted prediction, the value of the prediction mode flag information is a fifth value.

It should be noted that, in the embodiments of the present application, the fourth value and the fifth value are different, and the fourth value and the fifth value may be in parameter form or in digital form. Optionally, the prediction mode flag information may be a parameter written in a profile, or may be a value of a flag, which is not specifically limited here.

Exemplarily, for the fourth value and the fifth value, the fourth value may be set to 1, and the fifth value may be set to 0; or, the fourth value may be set to true, and the fifth value may be set to false, which is not specifically limited here.

It should also be noted that, in the embodiments of the present application, it may be determined, by certain conditions, whether the CP-CCCM mode is used for the current block for chroma prediction, to determine a final inter chroma prediction value, which are not limited to the following four manners. Exemplarily, the four manners may be as follows.

Manner 1: it is determine whether to use the CP-CCCM mode by comparing a threshold T_Distortion1 with a residual between a reconstructed luma of the first prediction block and a luma of the current block, such as SAD, MSE, SATD or SSE (or corresponding information of the luma residual of the current block).

Manner 2, on the basis of using the CP-CCCM mode in Manner 1, it is determined whether to use the chroma prediction value of the CP-CCCM mode to replace an original inter weighted chroma prediction value by comparing a threshold T_Distortion2 with a distortion between a chroma reconstructed value of the first prediction block and a chroma prediction value of the CP-CCCM mode of the first prediction block, such as SAD, MSE, SATD or SSE.

Manner 3, calculated filtering coefficients of target filter are used in a filter template of the current block to obtain a CP-CCCM prediction value of the template; a template of the first prediction block is obtained for weighted prediction to obtain a weighted template prediction value; and then the weighted template prediction value and a CP-CCCM chroma prediction value of the template are respectively calculated for distortion with respect to reconstructed chroma of the template of the current block, such as SAD, MSE, SATD or SSE, to determine whether to use the chroma prediction value of the CP-CCCM mode of the current block to replace the weighted chroma prediction value of the current block.

Manner 4, at the encoding end, a Flag may be transmitted to indicate whether to use the chroma prediction value of the CP-CCCM mode of the current block to replace the weighted chroma prediction value of the current block; so that at the decoding end, the Flag may be parsed to determine whether to use the chroma prediction value of the CP-CCCM mode of the current block to replace the weighted chroma prediction value of the current block.

The present embodiment provides an encoding method, in which, the prediction parameters of the current block are determined; the first prediction block of the current block is determined according to the prediction parameters; the model parameters are determined according to the first color component value and the second color component value of the first prediction block; the reference sample value of the first color component sample of the current block is determined, and the prediction value of the second color component sample of the current block is determined according to the reference sample value of the first color component sample of the current block and the model parameters; and the prediction residual value of the second color component sample of the current block is determined according to the prediction value of the second color component sample of the current block. In this way, the model parameters determined according to the first color component value and the second color component value of the first prediction block sufficiently reflect the correlation between luma and chroma of the prediction block, and the correlation is applied to existing luma information of the current block for chroma prediction, so that the accuracy of inter chroma prediction may be improved, and the coding efficiency may be improved, thereby improving the coding performance.

In another embodiment of the present application, the embodiments of the present application further provides a bitstream, which is generated by bit encoding according to information to be encoded; where the information to be encoded may include at least one of:
a prediction residual value of a second color component sample of a current block, prediction parameters of the current block, the number of coefficients of a target filter, a shape of the target filter, a value of a filter shape parameter, first flag information of a block category of the current block, or second flag information of the block category of the current block.

In the embodiments of the present application, after the prediction residual value of the second color component sample of the current block is transmitted from the encoding end to the decoding end, the decoding end obtains the prediction residual value of the second color component sample by decoding, and then obtains the prediction parameters of the current block by decoding, so that the prediction value of the second color component sample may be determined; and restores the reconstructed value of the second color component sample of the current block according to the prediction value of the second color component sample and the prediction residual value of the second color component sample.

In another embodiment of the present application, based on the encoding method and decoding method described in the aforementioned embodiments, in the inter prediction process, matching block information of the current block is the encoded reconstructed information, and the weighted prediction information of the current block is also known, which includes whether the reference picture list is valid, the reference picture index, and the color component index, etc. The embodiments of the present application propose the CP-CCCM technology that utilizes the matching block information and the weighted prediction information.

In the embodiments of the present application, the input of CP-CCCM includes: the position (xTbCmp, yTbCmp) of the chroma sample of the current block in the picture, the width nTbW of the current block and the height nTbH of the current block. The output of CP-CCCM includes: chroma prediction value of the current block, predSamples[x][y], x=0, 1, . . . , nTbW−1, y=0, 1, . . . , nTbH−1. The prediction process of the CP-CCCM technology may include steps such as determining core parameters of the CP-CCCM mode, obtaining input information, chroma prediction based on a convolution cross-component model, and a post-processing process. After these steps, the chroma prediction value of the current block may be obtained.

In an embodiment, referring to FIG. 10, a schematic flowchart of a CP-CCCM prediction provided by the embodiments of the present application is illustrated. As shown in FIG. 10, the process may include following contents.

S1001, core parameters of a CP-CCCM mode are determined.

It should be noted that, for S1001, determining the core parameters involved in the CP-CCCM mode may be configured or may be obtained or inferred in some way, for example, at the decoding end, the core parameters of the CP-CCCM mode is obtained from a bitstream.

Here, the determination of the core parameters includes but is not limited to a reference picture (inter_pred_idc), the number of convolution filter taps (nTap) based on the convolution cross-component model, a shape of a convolution filter (FilterIdx) based on the convolution cross-component model, and the number of chroma prediction sample outputs (predCpcccm) based on the convolution cross-component model (which is arranged as predSizeW×predSizeH), which are used by the CP-CCCM mode. Here, the number of chroma prediction sample outputs (predCpcccm) based on the convolution cross-component model may be related to the size parameters of the current block (e.g., predSizeW is equal to nTbW, predSizeH is equal to nTbH, or predSizeW is equal to nTbW/4, predSizeH is equal to nTbH/4). FilterIdx indicates the shape of the filter. For example, in a case where the shape of the filter is a diamond, FilterIdx is 0; in a case where the shape of the filter is a cross, FilterIdx is 1; in a case where the shape of the filter is a rectangle, FilterIdx is 2, and so on. In addition, inter_pred_idc may be used to indicate whether the current block uses the reference picture in List0, the reference picture in List1, or bi-prediction. In a case where inter_pred_idc is 0, the reference picture in List0 is used; in a case where inter_pred_idc is 1, the reference picture in List1 is used; in a case where inter_pred_idc is 2, the reference pictures in List0 and List1 are used; in a case where inter_pred_idc does not exist, the reference picture in List0 is used.

The determination of the core parameters of CP-CCCM is affected by the block size, block content or the number of samples in the block under certain conditions. For example:
during the encoding process, if the block sizes applied by the CP-CCCM mode has a large difference, or the block contents applied by the CP-CCCM mode has a large difference, or the number of samples in the block applied by the CP-CCCM mode has a large difference, the current block may be classified according to its block size, block content, or the number of samples in the block, and the core parameters may be determined according to different categories. That is, the reference picture (inter_pred_idc) or the number of convolution filter taps (nTap) or the shape of the convolution filter (FilterIdx) or the number of chroma prediction outputs (predCpcccm) based on the convolution cross-component model (which is arranged as predSizeW×predSizeH), which are used by CP-CCCM, may be determined according to the classification category. It should be noted that predSizeW and predSizeH may be the same or different.

In order to better illustrate the core parameters of the CP-CCCM mode, two simple classifications are used as examples.

Classification example 1: the CP-CCCM mode may classify the current block according to the width and height of the current block, and cpcccmSizeId is used to indicate the category of the current block. For different categories of blocks, the reference picture (inter_pred_idc) or the number of convolution filter taps (nTap) or the shape of the convolution filter (FilterIdx) or the number of chroma prediction outputs (predCpcccm) based on the convolution cross-component model (which is arranged as predSizeW×predSizeH), which are used by the CP-CCCM mode, may be determined according to the category of the current block. Here, an example classified into 3 categories is used as an illustration.

Different current blocks are classified into three categories according to the width and height of the current block. The reference picture (inter_pred_idc), the number of convolution filter taps (nTap), the shape of the convolution filter (FilterIdx), and the number of chroma prediction outputs (predCpcccm) based on the convolution cross-component model, which are used by different categories, may be set to the same or different. nTbW is the width of the current block, nTbH is the height of the current block, and the category (cpcccmSizeId) of the current block is defined as follows.

The current block with min (nTbW, nTbH)<=8, cpcccmSizeId=0. The used reference picture (inter_pred_idc) is List1, the number of the used convolution filter taps (nTap) is 3, the shape of the used convolution filter (FilterIdx) is 2, and the used chroma prediction outputs based on the convolution cross-component model is nTbH×nTbW chroma prediction values.

The current block with 8<min (nTbW, nTbH)<=32, cpcccmSizeId=1. The used reference picture (inter_pred_idc) is List0, the number of the used convolution filter taps (nTap) is 5, the shape of the used convolution filter (FilterIdx) is 1, and the used chroma prediction outputs based on the convolution cross-component model is nTbH×nTbW chroma prediction values.

The current block with min (nTbW, nTbH)>32, cpcccmSizeId=2. The used reference picture (inter_pred_idc) includes List0 and List1, the number of the used convolution filter taps (nTap) is 9, the shape of the used convolution filter (FilterIdx) is 0, and the used chroma prediction outputs based on the convolution cross-component model is nTbH×nTbW chroma prediction values.

The quantitative relationships of the above core parameters are expressed in tabular form, as shown in Table 1.

TABLE 1

| | inter_{—} | | | | |
|---|---|---|---|---|---|
| | pred_{—} | | | | |
| cpcccmSizeId | idc | nTap | FilterIdx | predSizeH | predSizeW |
| 0 | 1 | 3 | 2 | nTbH | nTbW |
| 1 | 0 | 5 | 1 | nTbH | nTbW |
| 2 | 2 | 9 | 0 | nTbH | nTbW |

Classification Example 2: the CP-CCCM mode may also classify the current block according to the number of samples in the current block, and cpcccmSizeId is used to indicate the category of the current block. For different categories of blocks, the reference picture (inter_pred_idc) or the number of convolution filter taps (nTap) or the shape of the convolution filter (FilterIdx) or the number of chroma prediction outputs (predCpcccm) based on the convolution cross-component model (which is arranged as predSizeW×predSizeH), which are used by the CP-CCCM mode, may be determined according to the category of the current block. Here, an example classified into 3 categories is used as an illustration.

Different current blocks are classified into three categories according to the number of samples in the current block. The reference pictures (inter_pred_idc), the number of convolution filter taps (nTap), the shape of the convolution filter (FilterIdx), and the number of chroma prediction outputs (predCpcccm) based on the convolution cross-component model, which are used by different categories, may be set to the same or different. nTbW is the width of the current block, nTbH is the height of the current block, and the category (cpcccmSizeId) of the current block is defined as follows.

The current block with (nTbW×nTbH)<=64, cpcccmSizeId=0. The used reference picture (inter_pred_idc) is List0, the number of the used convolution filter taps (nTap) is 4, the shape of the used convolution filter (FilterIdx) is 2, and the used chroma prediction outputs based on convolution cross-component model is nTbH×nTbW chroma prediction values.

The current block with 64< (nTbW×nTbH)<=256, cpcccmSizeId=1. The used reference picture (inter_pred_idc) is List0, the number of the used convolution filter taps (nTap) is 7, the shape of the used convolution filter (FilterIdx) is 1, and the used chroma prediction outputs based on convolution cross-component model is nTbH/2×nTbW/2 chroma prediction values.

The current block with (nTbW×nTbH)>256, cpcccmSizeId=2. The used reference picture (inter_pred_idc) is List0, the number of the used convolution filter taps (nTap) is 9, the shape of the used convolution filter (FilterIdx) is 0, and the used chroma prediction outputs based on convolution cross-component model is nTbH/4×nTbW/4 chroma prediction values.

The quantitative relationships of the above core parameters are expressed in tabular form, as shown in Table 2.

TABLE 2

| | inter_{—} | | | | |
|---|---|---|---|---|---|
| | pred_{—} | | | | |
| cpcccmSizeId | idc | nTap | FilterIdx | predSizeH | predSizeW |
| 0 | 0 | 4 | 2 | nTbH | nTbH |
| 1 | 0 | 7 | 1 | nTbH/2 | nTbH/2 |
| 2 | 0 | 9 | 0 | nTbH/4 | nTbH/4 |

S1002, input information is determined according to the core parameters, where the input information includes matching block information of the current block and luma prediction information of the current block.

It should be noted that, for S1002, in a case of predicting the current block, MV (motion vector) information of the current block is known, a matching block may be found in a corresponding reference picture via the MV information of the current block and the core parameter inter_pred_idc. In a case where inter_pred_idc is 2, the matching block obtained in the List0 reference picture includes a reconstructed luma block refRecY0 and a reconstructed chroma block refRecC0, and the matching block obtained in the List1 reference picture includes a reconstructed luma block refRecY1 and a reconstructed chroma block refRecC1; in a case where inter_pred_idc is 0, the matching block obtained in the List0 reference picture only include the reconstructed luma block refRecY0 and the reconstructed chroma block refRecC0; or in a case where inter_pred_idc is 1, the matching block obtained in the List1 reference picture only include the reconstructed luma block refRecY1 and the reconstructed chroma block refRecC1. In this case, the weighted prediction information (i.e., luma prediction information) of the current block is also known, and the weighted prediction may be performed on the reconstructed luma blocks refRecY0 and/or refRecY1 of the matching block through the weight information, to obtain the prediction luma block currPredY of the current block as the existing luma information of the current block.

In addition, refRecY0, refRecC0, refRecY1, refRecC1, or currPredY may be used as the chroma prediction input based on the convolution cross-component model after the pre-processing operation under certain conditions.

Exemplarily, in order to improve the quality of the input information, refRecY0, refRecC0, refRecY1, refRecC0, or currPredY may be subjected to different filtering enhancement operations.

Exemplarily, in a case where the resolution ratios of the chroma component and the luma component are inconsistent, the operation, such as up-sampling filtering or down-sampling filtering, may be performed on refRecY0, refRecC0, refRecY1, refRecC0, or curPredY, to facilitate the subsequent chroma prediction calculation.

In the embodiments of the present application, the determined input information may include: matching block information determined according to inter_pred_idc, such as the reconstructed luma block refRecY0, the reconstructed chroma block refRecC0, and/or, the reconstructed luma block refRecY1, the reconstructed chroma block refRecC1 (if refRecY0, refRecC0, refRecY1 and refRecC1 need to be pre-processed, they have been processed by the pre-processing operation); luma prediction information currPredY of the current block obtained according to the weight information and the reconstructed luma block refRecY0 and/or refRecY1 of the matching block (if refRecY0, refRecY1 need to be pre-processed, they have been processed by the pre-processing operation), where if currPredY need to be pre-processed, it has been processed by the pre-processing operation.

S1003, chroma prediction calculation based on the convolution cross-component model is performed according to the determined input information, to determine a chroma prediction value of the current block.

It should be noted that, for S1003, the chroma prediction value C^{pred}[i][j] within the size specified by the core parameters is determined, where i=0, 1, . . . , predSizeW−1, j=0, 1, . . . , predSizeH−1. Here, predSizeH and predSizeW are core parameters determined according to the size of the chroma prediction block, which may be the same as or different from the height nTbH or width nTbW of the current block. In this way, under certain conditions, the following calculation may be performed only on a portion of samples to be predicted in the current block.

It should also be noted that, for S1003, the following operations may be included: after determining the tap coefficient of the convolution filter, weighted prediction is performed according to the tap coefficient to obtain the chroma prediction value based on the convolution cross-component model. The process of determining the tap coefficient of the convolution filter mainly includes determining the reconstructed luma information and the reconstructed chroma information of the matching block used to calculate the filter coefficients, and calculating the filter coefficients using the reconstructed luma information and the reconstructed chroma information of the matching block.

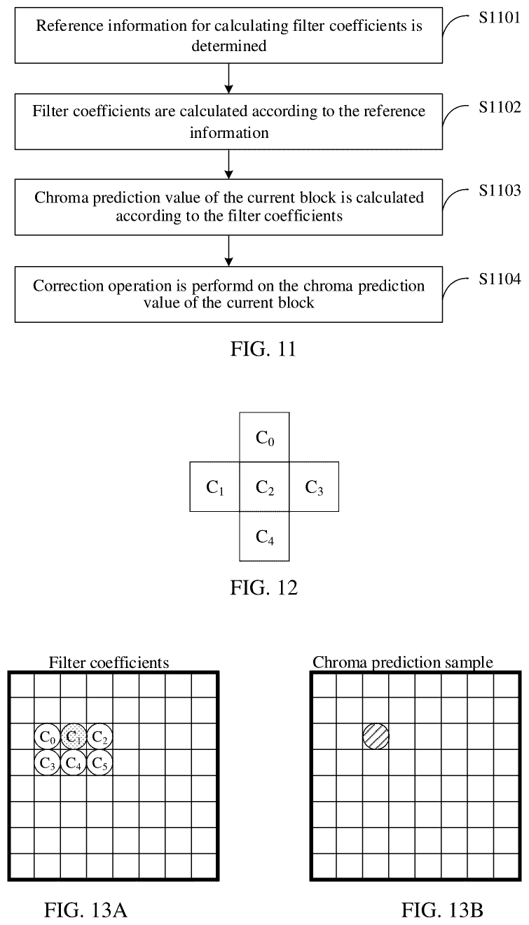

In some embodiments, for S1003, as shown in FIG. 11, this step may include following contents.

S1101, reference information for calculating filter coefficients is determined.

It should be noted that the filter coefficients here are the coefficients of the target filter in the aforementioned embodiments, and may also be called the number of filter taps. According to the core parameters (the number of filter taps nTap and the shape of the filter FilterIdx) determined by the CP-CCCM mode, a filter may be determined, for example, a filter in a case where nTap is 5 and the shape of the filter FilterIdx is 1. This filter is shown in FIG. 12.

Here, after obtaining the number of filter taps and shape information according to the core parameters, it is necessary to calculate the filter coefficients using refRecY0 and refRecC0, or refRecY1 and refRecC1, and a set of filter coefficients will be calculated for each current block. In a case where inter_pred_idc is 0, only refRecY0 and refRecC0 are used to calculate the filter coefficients; in a case where inter_pred_idc is 1, only refRecY1 and refRecC1 are used to calculate the filter coefficients; in a case where inter_pred_idc is 2, the filter coefficients may be calculated according to refRecY0 and refRecC0, or the filter coefficients may be calculated according to refRecY1 and refRecC1. Exemplarily, the distortion measurement criteria, such as SAD, SATD, MSE, between refRecY0 (or refRecY1) and currPredY may be compared, and then it is determined whether to use refRecY0 and refRecC0 to calculate the filter coefficients or to use refRecY1 and refRecC1 to calculate the filter coefficients, where the smaller the distortion, the more likely it will be used for calculating the filter coefficients; alternatively, the weight information of the forward matching block and the backward matching block, e.g., the BCW weight information, may be compared for determination, and the larger the weight, the more likely it will be used for calculating the filter coefficients; alternatively, the distortions, such as SAD, SATD, MSE between the adjacent templates of the forward matching block and the current block template, and the adjacent templates of the backward matching block and the current block template, may be compared for determination, and the larger the distortion, the less likely it will be used for calculating the filter coefficients, which is not limited in the embodiments of the present application.

In this way, reference information for calculating filter coefficients may be determined, which may be the luma reconstructed information refRecY and the chroma reconstructed information refRecC of the matching block.

S1102, filter coefficients are calculated according to the reference information.

It should also be noted that after obtaining the reference information for calculating the filter coefficients, the reference information here may include reference luma information and reference chroma information. The reference information may be reconstructed information, or may be derived based on the reconstructed information. Taking the reference information as reconstructed information as an example, after obtaining the reference information (including the luma reconstructed information refRecY and the chroma reconstructed information refRecC), a set of filter coefficients may be derived by minimizing the MSE between the chroma reconstructed value and the chroma value predicted by CP-CCCM, as shown in the aforementioned formula (12).

The process of minimizing the MSE to derive the filter coefficients is shown in the aforementioned formulas (13) to (19), which will not be described in detail here. Specifically, by solving the system of linear equations shown in formula (18), a set of filter coefficients may be obtained, which minimizes the MSE between an expected output after filtering (i.e., the chroma value predicted by CP-CCCM) and chroma reconstructed value of the expected output, i.e., Wiener filtering coefficients. The set of Wiener filtering coefficients is the set of filter coefficients of the current block. In addition, in the process of solving the system of linear equations, an autocorrelation matrix of the luma reconstructed information refRecY is first calculated; a cross-correlation vector of the luma reconstructed information refRecY and the chroma reconstructed information refRecC is calculated, and then the autocorrelation matrix is subjected to Cholesky decomposition or LDL decomposition, finally, each filter coefficient cₙ is calculated in sequence by reverse recursion.

S1103, a chroma prediction value of the current block is calculated according to the filter coefficients.

It should also be noted that, for each current block, a set of filter coefficients may be obtained in the above manner, and the set of filter coefficients are c₀, c₁, c₂, . . . , C_{nTap-1}, and the set of filter coefficients may be fixed-point or not. Then, a convolution operation is performed on the luma sample value corresponding to the current chroma sample to be predicted according to the shape of the filter and filter coefficients, such as a co-located luma reference value. The co-located luma reference value may be a co-located luma sample value of the chroma sample, or a value of the luma sample value after filtering. The calculation process of the chroma prediction value is as follows.

Assuming that the shape of the filter is rectangular, that is, FilterIdx is 2, and the number of filter taps nTap is 6, the filter (or called “filter template”) is shown in FIG. 13A, where C₀ to c₅ are the filter coefficients in the filter respectively. The filter coefficient c₁ corresponds to a co-located luma point Y^{colocated}[i][j] corresponding to the current chroma sample to be predicted C^{pred}[i][j]. The co-located luma point may be the current prediction luma curpredY[i][j] obtained by weighting the corresponding point of the matching block; the remaining points are luma points neighboring the current spatial position (it should be note that the neighboring luma points may be obtained via up-sampling filtering, down-sampling filtering or other operations, just as the co-located luma point is). In this way, according to the filter template in FIG. 13A, the final chroma prediction samples C^{pred}[i][j] are shown as black dots in FIG. 13B. In an embodiment, the calculation process of the chroma prediction value is as follows.

For the position (i, j) of the co-located luma sample of the current chroma to be predicted, its luma sample position in the filter template is (k, l), and the corresponding luma sample is FilterY[k][l]. So that, for the sample (k, l) in the filter template at the sample position (i, j), its filter coefficients are defined as c_{i,j,k,l}, that is:

$${c}_{i , j , k , l} = {c}_{n} \qquad ( 24 )$$

Here, n=0,1, . . . , nTap−1, i=0, . . . , predSizeW−1, j=0, . . . , predSizeH−1. It should be noted that, in a case where k=i, l=j, it is the current co-located luma sample, that is, colocatedY[i][j]=FilterY[k][l].

In a case where k=i=0, . . . , predSizeW−1, and l=j=0, . . . , predSizeH−1, FilterY[k][l]=currpredY[k][l].

Based on above, for i=0, . . . , predSizeW−1, j=0, . . . , predSizeH−1:

$${C}^{pred} [ i ] [ j ] = {\sum }_{k , l} FilterY [ k ] [ l ] \times {C}_{i , j , k , l} \qquad ( 25 )$$

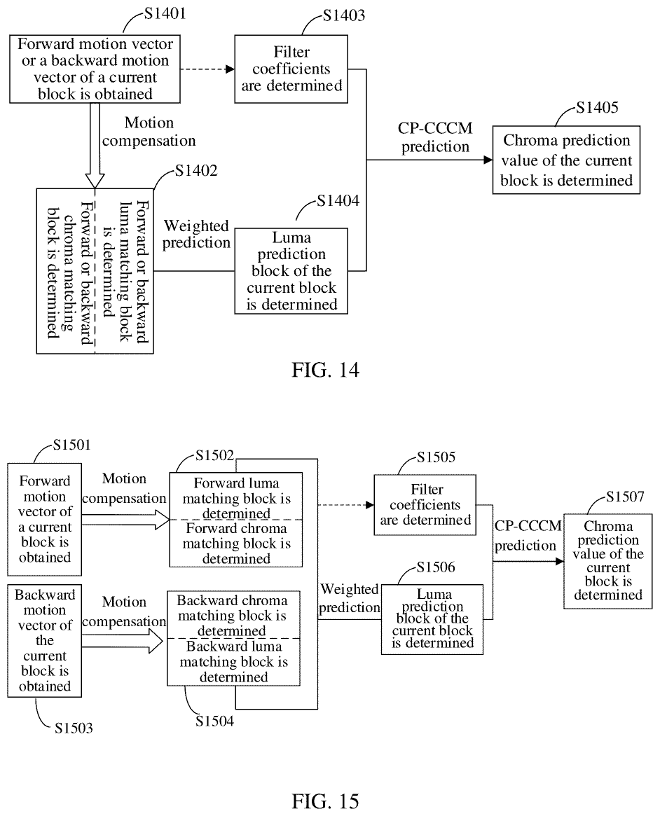

In a possible implementation, in a case where inter_pred_idc is 0 or 1, uni-prediction in CP-CCCM mode is performed, and the uni-prediction process is shown in FIG. 14, which may include following contents.

S1401, a forward motion vector or a backward motion vector of a current block is obtained.

S1402, a forward or backward luma matching block is determined, and a forward or backward chroma matching block is determined.

S1403, filter coefficients are determined.

S1404, a luma prediction block of the current block is determined.

S1405, a chroma prediction value of the current block is determined by performing CP-CCCM prediction.

In another possible implementation, in a case where inter_pred_idc is 2, bi-prediction in CP-CCCM mode is performed, and the uni-prediction process is shown in FIG. 15, which may include following contents.

S1501, a forward motion vector of a current block is obtained.

S1502, a forward luma matching block is determined, and a forward chroma matching block is determined.

S1503, a backward motion vector of the current block is obtained.

S1504, a backward luma matching block is determined, and a backward chroma matching block is determined.

S1505, filter coefficients are determined.

S1506, a luma prediction block of the current block is determined.

S1507, a chroma prediction value of the current block is determined by performing CP-CCCM prediction.

S1104, correction operation is performed on the chroma prediction value of the current block.

It should also be noted that, in the embodiments of the present application, the chroma prediction value should be limited in a preset numerical range. If it exceeds the preset numerical range, corresponding correction operations should be performed. For example:
a clip operation may be performed on the chroma prediction value of C^{pred}[i][j] as follows.

In a case where the value of C^{pred}[i][j] is less than 0, it is set to 0.

In a case where the value of C^{pred}[i][j] is greater than (1<<BitDepth)−1, it is set to (1<<BitDepth)−1.

BitDepth is the bit depth required by the chroma sample value, which ensures that all chroma prediction values in predCpcccm are between 0 and (1<<BitDepth)−1.

The clip operation may be indicated as follows:

$${C}^{pred} [ i ] [ j ] = Clip 3 ( 0 , ( 1 ≪ BitDepth ) - 1 , {C}^{pred} [ i ] [ j ] ) \qquad ( 26 )$$

where

$$Clip 3 ( x , y , z ) = \{ \begin{matrix}x ; & z < x \\ y ; & z > y \\ z ; & otherwise\end{matrix} \qquad ( 27 )$$

S1004, a post-processing operation is performed on the chroma prediction value of the current block, to determine a target chroma prediction value of the current block.

It should also be noted that, under a certain condition, the chroma prediction output predCpcccm based on the convolutional cross-component model needs to be post-processed, to be used as the final target chroma prediction value predSamples, otherwise the final target chroma prediction value predSamples is predCpcccm.

Exemplarily, in a case where predSizeW in the core parameters of the CP-CCCM is not equal to the width of the current block nTbW, or predSizeH in the core parameters of the CP-CCCM is not equal to the height of the current block nTbH, it is necessary to perform an up-sampling or down-sampling operation on predCpcccm, to obtain the final target chroma prediction value predSamples.

Exemplarily, in order to improve the quality of the chroma prediction of the CP-CCCM, filtering enhancement may be performed on predCpcccm, to be as the final target chroma prediction value predSamples.

Exemplarily, in order to further improve the accuracy of the CP-CCCM prediction value, weighted fusion may be performed on the chroma prediction value calculated by the original chroma weighted prediction and the chroma prediction value predCpcccm calculated by the CP-CCCM, and the fusion result may be used as the final target chroma prediction value predSamples.

Exemplarily, in order to improve the prediction performance of CP-CCCM, a neural network may be used to correct the prediction output predCpcccm of CP-CCCM.

It may also be understood that, in the embodiments of the present application, the obtained input information includes the reconstructed luma and reconstructed chroma of the List0 matching block or the List1 matching block, which are used for calculating the filter coefficients, and the existing luma information of the current block, where the existing luma information of the current block is the weighted luma value currPredY of the forward matching block and/or the backward matching block.

In the embodiments of the present application, the weighted luma value may be replaced with the existing luma reconstructed value currecY of the current block, that is, the luma sample is reconstructed and stored first, and the stored luma reconstructed information of the current block is used for chroma prediction of the current block. Alternatively, in the embodiments of the present application, the reconstructed luma refRecTemplateY and the reconstructed chroma refRecTemplateC of the neighbouring template of the List0 matching block or the List1 matching block may be used as input information for calculating the filter coefficients.

It may also be understood that, in the embodiments of the present application, the filter coefficients finally calculated are the tap coefficients corresponding to the filter template, that is, the number of filter coefficients is equal to the number of taps (nTap) of the filter template. In addition, several biases may be added to the filter. Exemplarily, in the embodiments of the present application, in a case where FilterIdx=1, nTap=5 is a cross filter, in a case where the filter coefficients are the tap coefficients c₀ to c₄ corresponding to the filter templates, and the chroma prediction value obtained by calculating the position (i, j) is as shown in formula (22), if the bias can be added, it is as shown in formula (23).

Bias may include coefficient terms involved in the calculation of filter coefficients, e.g., bias=cₙ×Constant. Here, Constant may be a fixed constant, e.g., Constant=1<< (BitDepth−1); it may also be a value related to a co-located luma sample value at position (i, j), e.g., Constant=f(FilterY[i][j]); it may also be a value related to a luma sample value corresponding to a tap of the filter template other than the co-located luma sample value at position (i, j), e.g., Constant=f(FilterY[k][l]). Constant=f(FilterY[i][j]) or Constant=f(FilterY[k][l]) may be a linear mapping relationship or a nonlinear mapping relationship, which is not specifically limited here.

In addition, bias may not include coefficient terms involved in the calculation of filter coefficients, e.g., bias=Constant. Here, Constant may be a fixed constant, e.g., Constant=1<<(BitDepth−1); it may also be a value related to a co-located luma sample value at position (i, j), e.g., Constant=f(FilterY[i][j]); it may also be a value related to a luma sample value corresponding to a tap of the filter template other than the co-located luma position (i, j), e.g., Constant=f(FilterY[k][l]). Constant=f(FilterY[i][j]) or Constant=f(FilterY[k][l]) may be a linear mapping relationship or a nonlinear mapping relationship, which is not specifically limited here.

Through the above embodiments, the implementations of the aforementioned embodiments are described in detail, it may be seen that a new inter chroma prediction technology CP-CCCM is proposed in the present embodiments, which uses the matching block information of the current block to obtain the filter coefficients, and the filter coefficients is applied to the existing luma information of the current block for chroma prediction. On the one hand, CP-CCCM makes full use of the matching block luma and chroma information of the current block to realize the calculation of the filter coefficients, and the filter coefficients sufficiently reflect the correlation between luma and chroma of the matching block; on the other hand, CP-CCCM makes full use of the existing luma information of the current block, and make the filter coefficients that may reflect the correlation between luma and chroma apply to the existing luma information of the current block, to realize chroma prediction. In this way, determining the filter coefficients according to the reconstructed luma and reconstructed chroma information of the matching block, in which, the filter coefficients are calculated by minimizing the MSE between the prediction chroma (actual chroma output is equal to a product of the filter coefficients and the reconstructed luma) and the reconstructed chroma (expected output) of the matching block. The filter coefficients sufficiently reflect the correlation between the reconstructed luma and the reconstructed chroma of the matching block, and the correlation is applied to the existing luma information of the current block for chroma prediction, which improves the accuracy of inter chroma prediction to a certain extent, thereby improving coding efficiency, and further improving coding performance.

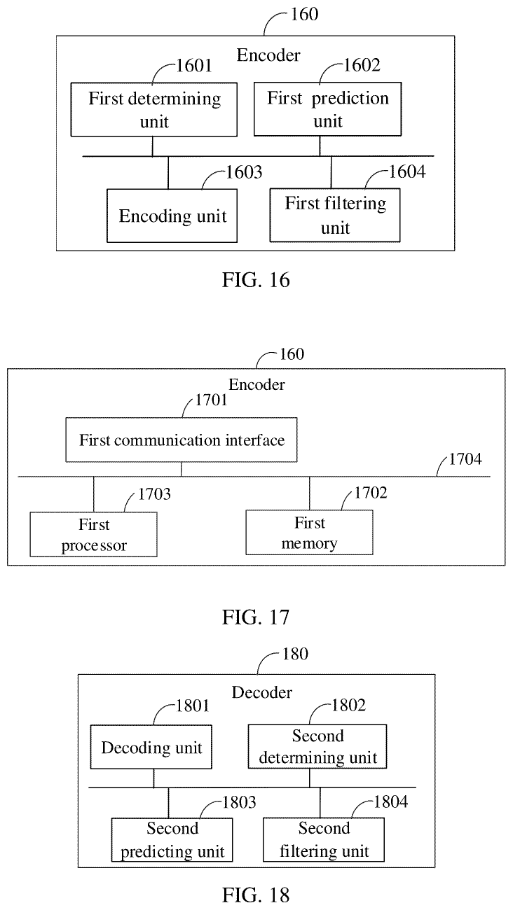

In yet another embodiment of the present application, based on the same inventive concept as the aforementioned embodiments, referring to FIG. 16, a schematic diagram of a composition structure of an encoder 160 provided by the embodiments of the present application is illustrated. As shown in FIG. 16, the encoder 160 may include: a first determining unit 1601 and a first prediction unit 1602; where
the first determining unit 1601 is configured to determine prediction parameters of a current block; and determine a first prediction block of the current block according to the prediction parameters;
the first determining unit 1601 is further configured to determine model parameters according to a first color component value and a second color component value of the first prediction block;
the first prediction unit 1602 is configured to determine a reference sample value of a first color component sample of the current block, and determine a prediction value of a second color component sample of the current block according to the reference sample value of the first color component sample of the current block and the model parameters;
the first determining unit 1601 is further configured to determine a prediction residual value of the second color component sample of the current block according to the prediction value of the second color component sample of the current block.

In some embodiments, the first determining unit 1601 is further configured to determine an initial value of a second color component sample of the current block; and determine the prediction residual value of the second color component sample of the current block according to the initial value of the second color component sample of the current block and the prediction value of the second color component sample of the current block.

In some embodiments, referring to FIG. 16, the encoder 160 may further include an encoding unit 1603, which is configured to encode the prediction residual value of the second color component sample of the current block, and write the obtained encoded bits into a bitstream.

In some embodiments, the encoding unit 1603 is further configured to encode the prediction parameters, and write the obtained encoded bits into the bitstream.

In some embodiments, the prediction parameters include: a motion vector, a reference picture index, and an inter prediction flag parameter, where the inter prediction flag parameter indicates a prediction mode used for encoding the current block, and the prediction mode includes List0 prediction, List1 prediction, and bi-prediction.

In some embodiments, the inter prediction flag parameter indicates that the prediction method used for encoding the current block is the bi-prediction.

In some embodiments, the first determining unit 1601 is further configured to determine a List0 prediction block of the current block, a List1 prediction block of the current block according to the prediction parameters.

In some embodiments, the first determining unit 1601 is further configured that the first prediction block is the List0 prediction block of the current block; or the first prediction block is the List1 prediction block of the current block; or the first prediction block includes the List0 prediction block of the current block and the List1 prediction block of the current block.

In some embodiments, the first determining unit 1601 is further configured that the model parameters include coefficients of a target filter.

In some embodiments, the first determining unit 1601 is further configured to determine the coefficients of the target filter according to the first color component value and the second color component value of the first prediction block.

In some embodiments, the first determining unit 1601 is further configured that the coefficients of the target filter are coefficients used by the target filter in a case where a first error between an output value of the second color component value of the first prediction block processed by the target filter and an output value of the first color component value of the first prediction block processed by the target filter meets a first condition.

In some embodiments, the first determining unit 1601 is further configured that the first condition is that the first error is minimum.

In some embodiments, the first determining unit 1601 is further configured that the first condition is that the first error is within a first preset threshold range.

In some embodiments, the first determining unit 1601 is further configured that the first condition is that a variation of the first error is within a second preset threshold range.

In some embodiments, the first determining unit 1601 is further configured to determine autocorrelation parameters according to the first color component value of the first prediction block; determine cross-correlation parameters according to the first color component value and the second color component value of the first prediction block; and determine the coefficients of the target filter according to the autocorrelation parameters and the cross-correlation parameters.

In some embodiments, the first determining unit 1601 is further configured to determine the number of coefficients of the target filter.

In some embodiments, the encoding unit 1603 is further configured to encode the number of coefficients of the target filter, and write the obtained encoded bits into the bitstream.

In some embodiments, the first determining unit 1601 is further configured that the number of coefficients of the target filter is equal to a first preset constant value.

In some embodiments, the first determining unit 1601 is further configured to determine first flag information of a block category of the current block; and determine the number of coefficients of the target filter according to the first flag information of the block category of the current block.

In some embodiments, the encoding unit 1603 is further configured to encode the first flag information of the block category of the current block, and write the obtained encoded bits into the bitstream.

In some embodiments, the first determining unit 1601 is further configured that the target filter is a one-dimensional or two-dimensional filter with a preset shape.

In some embodiments, the first determining unit 1601 is further configured to determine a shape of the target filter.

In some embodiments, the encoding unit 1603 is further configured to encode the shape of the target filter, and write the obtained encoded bits into the bitstream.

In some embodiments, the first determining unit 1601 is further configured to determine a value of a filter shape parameter, where the filter shape parameter indicates the shape of the target filter.

In some embodiments, the first determining unit 1601 is further configured to determine second flag information of a block category of the current block; and determine the value of the filter shape parameter according to the second flag information of the block category of the current block.

In some embodiments, the encoding unit 1603 is further configured to encode the value of the filter shape parameter, and write the obtained encoded bits into the bitstream.

In some embodiments, the encoding unit 1603 is further configured to encode the second flag information of the block category of the current block, and write the obtained encoded bits into the bitstream.

In some embodiments, the first determining unit 1601 is further configured to determine the reference sample value of the first color component sample of the current block according to a reconstructed value of the first color component sample of the current block.

In some embodiments, the first determining unit 1601 is further configured to determine the reconstructed value of the first color component sample of the current block according to the first color component value of the first prediction block.

In some embodiments, the first determining unit 1601 is further configured to determine the reconstructed value of the first color component sample of the current block according to a first color component value of a List0 prediction block of the current block and a first color component value of a List1 prediction block of the current block.

In some embodiments, the first determining unit 1601 is further configured to determine a prediction value of the first color component sample of the current block according to the first color component value of the first prediction block; and determine the reference sample value of the first color component sample of the current block according to the prediction value of the first color component sample of the current block.

In some embodiments, the first determining unit 1601 is further configured to determine the prediction value of the first color component sample of the current block according to the first color component value of a List0 prediction block of the current block and the first color component value of a List1 prediction block of the current block.

In some embodiments, the first determining unit 1601 is further configured to determine a List0 weighting factor of the List0 prediction block of the current block and a List1 weighting factor of the List1 prediction block of the current block; determine a weighted sum of the first color component value of the List0 prediction block of the current block and the first color component value of the List1 prediction block of the current block according to the List0 weighting factor and the List1 weighting factor; and determine the prediction value of the first color component sample of the current block according to the weighted sum.

In some embodiments, the first determining unit 1601 is further configured to determine a first input value of the target filter based on the reference sample value of the first color component sample of the current block; and the first prediction unit 1602 is further configured to determine a first output value of the target filter based on the first input value and the model parameter; and determine the prediction value of the second color component sample of the current block based on the first output value.

In some embodiments, referring to FIG. 16, the encoder 160 may further include a first filtering unit 1604, which is configured to perform a first filtering process on the reference sample value of the first color component sample of the current block, to determine the first input value.

In some embodiments, the first filtering unit 1604 is further configured that the first filtering process includes at least one of: low-pass filtering and down-sampling filtering.

In some embodiments, the first filtering unit 1604 is further configured that the first filtering process sets the first input value to be equal to a reference sample value of the first color component sample of the current block.

In some embodiments, the first filtering unit 1604 is further configured to perform a second filtering process on the first output value, to determine a second output value; and determine the prediction value of the second color component sample of the current block based on the second output value.

In some embodiments, the first filtering unit 1604 is further configured that the second filtering process includes at least one of: low-pass filtering, or up-sampling filtering.

In some embodiments, the first filtering unit 1604 is further configured that the second filtering process sets the second output value to be equal to the first output value.

In some embodiments, the first determining unit 1601 is further configured that the first output value includes a prediction value of a portion of the second color component sample of the current block.

In some embodiments, the first prediction unit 1602 is further configured to perform a first process on the second output value, to obtain the prediction value of the second color component sample of the current block.

In some embodiments, the first prediction unit 1602 is further configured that the first process is a clip operation that restricts the second output value within a preset value range.

In some embodiments, the first prediction unit 1602 is further configured to perform an additive operation according to the first output value and a first offset value, to determine the prediction value of the second color component sample of the current block.

In some embodiments, the first determining unit 1601 is further configured to set the first offset value to be equal to a preset constant value; or set the first offset value to be equal to a value of the first input value in a preset mapping relationship.

In some embodiments, the first determining unit 1601 is further configured to determine a prediction residual value of the first color component sample of the current block; and determine the reference sample value of the first color component sample of the current block according to the prediction residual value of the first color component sample of the current block.

In some embodiments, the first determining unit 1601 is further configured to determine a first color component residual value and a second color component residual value of the first prediction block; and determine the model parameters according to the first color component residual value and the second color component residual value of the first prediction block; and
the first prediction unit 1602 is further configured to determine an initial prediction residual value of the second color component sample of the current block according to the prediction residual value of the first color component sample of the current block and the model parameters; determine an initial prediction value of the second color component sample of the current block according to the first prediction block; and determine the prediction value of the second color component sample of the current block according to the initial prediction residual value and the initial prediction value of the second color component sample of the current block.

It may be understood that, in the embodiments of the present application, a “unit” may be a portion of a circuit, a portion of a processor, a portion of a program or software, etc. Of course, it may also be modular or non-modular. Furthermore, in the present embodiments, all components may be integrated into one processing unit, or each unit may physically exist separately, or two or more units may be integrated into one unit. The above integrated units may be implemented in the form of hardware or in the form of software function modules.

If the integrated units are implemented in the form of a software function module and are not sold or used as independent products, they may be stored in a non-transitory computer-readable storage medium. Based on the understanding, the technical solution of the embodiments in essential or a portion that contributes to the prior art or all or a portion of the technical solution may be embodied in the form of a software product. The computer software product is stored in a non-transitory storage medium and includes a number of instructions for enabling a computer device (which may be a personal computer, a server, or a network device, etc.) or a processor to perform all or a portion of the steps of the methods described in the present embodiments. The non-transitory storage medium includes a medium that may store program codes, such as a USB flash drive (U disk), a mobile hard disk, a read only memory (ROM), a random access memory (RAM), a diskette, or an optical disk.

Therefore, the embodiments of the present application provide a non-transitory computer-readable storage medium, which is applied to the encoder 160. The non-transitory computer-readable storage medium stores a computer program, when the computer program is executed by a first processor, the methods according to any one of the aforementioned embodiments are implemented.

Based on the composition of the encoder 160 and the non-transitory computer-readable storage medium, referring to FIG. 17, a schematic diagram of a hardware structure of the encoder 160 provided by the embodiments of the present application is illustrated. As shown in FIG. 17, the encoder 160 may include: a first communication interface 1701, a first memory 1702, and a first processor 1703; and these components are coupled together via a first bus system 1704. It may be understood that the first bus system 1704 is used to achieve connection and communication among these components. The first bus system 1704 includes not only a data bus but also a power bus, a control bus and a status signal bus. However, for the sake of clarity, various buses are labeled as the first bus system 1704 in FIG. 17, where
the first communication interface 1701 is configured to receive and transmit signals during the process of transmitting and receiving information with other external network elements;
the first memory 1702 is configured to store a computer program that is able to be run on the first processor 1703; and
the first processor 1703, is configured to perform following steps when running the computer program:
determining prediction parameters of a current block; determining a first prediction block of the current block according to the prediction parameters; determining model parameters according to a first color component value and a second color component value of the first prediction block; determining a reference sample value of a first color component sample of the current block; determining a prediction value of a second color component sample of the current block according to the reference sample value of the first color component sample of the current block and the model parameters; and determining a prediction residual value of the second color component sample of the current block according to the prediction value of the second color component sample of the current block.

It may be understood that, in the embodiments of the present application, the first memory 1702 may be a volatile (transitory) memory or a non-volatile (non-transitory) memory, or may include both the volatile memory and the non-volatile memory. Here, the non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. By way of exemplary illustration, rather than limiting illustration, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link (Synchlink) DRAM (SLDRAM) and a direct rambus RAM (DR RAM). The first memory 1702 of the systems and methods described in the present application is intended to include, but is not limited to, these and any other suitable types of memory.

The first processor 1703 may be an integrated circuit chip with signal processing capability. During implementation, each step of the above methods may be completed by an integrated logic circuit of hardware in the first processor 1703 or by instructions with software form in the first processor 1703. The first processor 1703 mentioned above may be a general purpose processor, a digital signal processor (DSP), an application specific integrated circuit (ASIC), a field programmable gate array (FPGA) or other programmable logic devices, discrete gate or transistor logic devices, and discrete hardware components, which may implemented or executed achieve the various methods, steps and logic diagrams disclosed in the embodiments of the present application. The general purpose processor may be a microprocessor, or the processor may be any conventional processor or the like. The steps of the method disclosed in the embodiments of the present application may be performed directly by a hardware decoding processor, or by a combination of hardware and software modules in the decoding processor. The software module may be located in a random access memory, a flash memory, a read-only memory, a programmable read-only memory, or an electrically erasable programmable memory, a register, or other mature storage media in the art. The non-transitory storage medium is located in the first memory 1702, and the first processor 1703 reads information in the first memory 1702 and completes the steps of the above methods in combination with its hardware.

It should be understood that the embodiments described herein may be implemented by hardware, software, firmware, middleware, microcode, or a combination thereof. For hardware implementation, the processing unit may be implemented in one or more application specific integrated circuits (ASIC), digital signal processors (DSP), digital signal processing devices (DSPD), programmable logic devices (PLD), field programmable gate arrays (FPGA), general purpose processors, controllers, microcontrollers, microprocessors, other electronic units for performing the functions described in the present application, or a combination thereof. For software implementation, the technology described in the application may be implemented through modules (such as procedures, functions) that execute the functions described in the application. The software codes may be stored in a memory and executed by a processor. The memory may be implemented within the processor or external to the processor.

Optionally, as another embodiment, the first processor 1703 is further configured to perform any one of the methods described in the aforementioned embodiments when running the computer program.

The present embodiment provides an encoder, in the encoder, the model parameters determined according to the first color component value and the second color component value of the first prediction block sufficiently reflect the correlation between luma and chroma of the prediction block, and the correlation is applied to the existing luma information of the current block for chroma prediction, so that the accuracy of inter chroma prediction may be improved and bit rate may be saved, and the coding efficiency may also be improved, thereby improving coding performance.

In yet another embodiment of the present application, based on the same inventive concept as the aforementioned embodiments, referring to FIG. 18, a schematic diagram of a composition structure of a decoder 180 provided by the embodiments of the present application is illustrated. As shown in FIG. 18, the decoder 180 may include: a decoding unit 1801, a second determining unit 1802, and a second predicting unit 1803; where
the decoding unit 1801 is configured to decode a bitstream to determine prediction parameters of a current block;
the second determining unit 1802 is configured to determine a first prediction block of the current block according to the prediction parameters; and determine model parameters according to a first color component value and a second color component value of the first prediction block;
the second prediction unit 1803 is configured to determine a reference sample value of a first color component sample of the current block, and determine a prediction value of a second color component sample of the current block according to the reference sample value of the first color component sample of the current block and the model parameters;
the second determining unit 1802 is further configured to determine a reconstructed value of the second color component sample of the current block according to the prediction value of the second color component sample of the current block.

In some embodiments, the prediction parameters include: a motion vector, a reference picture index, and an inter prediction flag parameter, where the inter prediction flag parameter indicates a prediction mode used for decoding the current block, and the prediction mode includes List0 prediction, List1 prediction, and bi-prediction.

In some embodiments, the inter prediction flag parameter indicates that the prediction mode used for decoding the current block is the bi-prediction.

In some embodiments, the second determining unit 1802 is further configured to determine a List0 prediction block of the current block, a List1 prediction block of the current block according to the prediction parameters.

In some embodiments, the second determining unit 1802 is further configured that the first prediction block is the List0 prediction block of the current block; or the first prediction block is the List1 prediction block of the current block; or the first prediction blocks includes the List0 prediction block of the current block and the List1 prediction block of the current block.

In some embodiments, the second determining unit 1802 is further configured that the model parameters include coefficients of a target filter.

In some embodiments, the second determining unit 1802 is further configured to determine the coefficients of the target filter according to the first color component value and the second color component value of the first prediction block.

In some embodiments, the second determining unit 1802 is further configured that the coefficients of the target filter are coefficients used by the target filter in a case where a first error between an output value of the second color component value of the first prediction block processed by the target filter and an output value of the first color component value of the first prediction block processed by the target filter meets a first condition.

In some embodiments, the second determining unit 1802 is further configured that the first condition is that the first error is minimum.

In some embodiments, the second determining unit 1802 is further configured that the first condition is that the first error is within a first preset threshold range.

In some embodiments, the second determining unit 1802 is further configured that the first condition is that a variation of the first error is within a second preset threshold range.

In some embodiments, the second determining unit 1802 is further configured to determine autocorrelation parameters according to the first color component value of the first prediction block; determine cross-correlation parameters according to the first color component value and the second color component value of the first prediction block; and determine the coefficients of the target filter according to the autocorrelation parameters and the cross-correlation parameters.

In some embodiments, the second determining unit 1802 is further configured that the number of coefficients of the target filter is equal to a first preset constant value.

In some embodiments, the decoding unit 1801 is further configured to decode the bitstream to determine the number of coefficients of the target filter.

In some embodiments, the second determining unit 1802 is further configured to determine first flag information of a block category of the current block; and determine the number of coefficients of the target filter according to the first flag information of the block category of the current block.

In some embodiments, the second determining unit 1802 is further configured that the target filter is a one-dimensional or two-dimensional filter with a preset shape.

In some embodiments, the decoding unit 1801 is further configured to decode the bitstream to determine a shape of the target filter.

In some embodiments, the second determining unit 1802 is further configured to determine a value of a filter shape parameter, where the filter shape parameter indicates the shape of the target filter.

In some embodiments, the second determining unit 1802 is further configured to determine second flag information of a block category of the current block; and determine the value of the filter shape parameter according to the second flag information of the block category of the current block.

In some embodiments, the second determining unit 1802 is further configured to determine the reference sample value of the first color component sample of the current block according to a reconstructed value of the first color component sample of the current block.

In some embodiments, the second determining unit 1802 is further configured to determine the reconstructed value of the first color component sample of the current block according to the first color component value of the first prediction block.

In some embodiments, the second determining unit 1802 is further configured to determine the reconstructed value of the first color component sample of the current block according to a first color component value of a List0 prediction block of the current block and a first color component value of a List1 prediction block of the current block.

In some embodiments, the second determining unit 1802 is further configured to determine a prediction value of the first color component sample of the current block according to the first color component value of the first prediction block; and determine the reference sample value of the first color component sample of the current block according to the prediction value of the first color component sample of the current block.

In some embodiments, the second determining unit 1802 is further configured to determine the prediction value of the first color component sample of the current block according to the first color component value of a List0 prediction block of the current block and the first color component value of a List1 prediction block of the current block.

In some embodiments, the second determining unit 1802 is further configured to determine a List0 weighting factor of the List0 prediction block of the current block and a List1 weighting factor of the List1 prediction block of the current block; determine, according to the List weighting factor and the List1 weighting factor, a weighted sum of the first color component value of the List0 prediction block of the current block and the first color component value of the List1 prediction block of the current block; and determine the prediction value of the first color component sample of the current block according to the weighted sum.

In some embodiments, the second determining unit 1802 is further configured to determine a first input value of the target filter based on the reference sample value of the first color component sample of the current block; and
the second prediction unit 1803 is further configured to determine a first output value of the target filter based on the first input value and the model parameters; and determine the prediction value of the second color component sample of the current block based on the first output value.

In some embodiments, referring to FIG. 18, the decoder 180 may further include a second filtering unit 1804, which is configured to perform a first filtering process on the reference sample value of the first color component sample of the current block, to determine the first input value.

In some embodiments, the second filtering unit 1804 is further configured that the first filtering process includes at least one of: low-pass filtering, or down-sampling filtering.

In some embodiments, the second filtering unit 1804 is further configured that the first filtering process sets the first input value to be equal to the reference sample value of the first color component sample of the current block.

In some embodiments, the second filtering unit 1804 is further configured to perform a second filtering process on the first output value, to determine a second output value; and determine the prediction value of the second color component sample of the current block based on the second output value.

In some embodiments, the second filtering unit 1804 is further configured that the second filtering process includes at least one of: low-pass filtering, or up-sampling filtering.

In some embodiments, the second filtering unit 1804 is further configured that the second filtering process sets the second output value to be equal to the first output value.

In some embodiments, the second determining unit 1802 is further configured that the first output value includes a prediction value of a portion of the second color component sample of the current block.

In some embodiments, the second prediction unit 1803 is further configured to perform a first process on the second output value, to obtain the prediction value of the second color component sample of the current block.

In some embodiments, the second prediction unit 1803 is further configured that the first process is a clip operation that restricts the second output value within a preset value range.

In some embodiments, the second prediction unit 1803 is further configured to perform an additive operation according to the first output value and a first offset value, to determine the prediction value of the second color component sample of the current block.

In some embodiments, the second determining unit 1802 is further configured to set the first offset value to be equal to a preset constant value; or set the first offset value to be equal to a value of the first input value in a preset mapping relationship.

In some embodiments, the second determining unit 1802 is further configured to determine a prediction residual value of the first color component sample of the current block; and determine the reference sample value of the first color component sample of the current block according to the prediction residual value of the first color component sample of the current block.

In some embodiments, the second determining unit 1802 is further configured to determine a first color component residual value and a second color component residual value of the first prediction block; and determine the model parameters according to the first color component residual value and the second color component residual value of the first prediction block;
the second prediction unit 1803 is further configured to determine an initial prediction residual value of the second color component sample of the current block according to the prediction residual value of the first color component sample of the current block and the model parameters; determine, according to the first prediction block, an initial prediction value of the second color component sample of the current block; and determine the prediction value of the second color component sample of the current block according to the initial prediction residual value and the initial prediction value of the second color component sample of the current block.

In some embodiments, the decoding unit 1801 is further configured to decode the bitstream to determine a prediction residual value of the second color component sample of the current block; and
the second determining unit 1802 is further configured to determine the reconstructed value of the second color component sample of the current block according to the prediction value of the second color component sample of the current block and the prediction residual value of the second color component sample of the current block.

It may be understood that, in the present embodiments, a “unit” may be a portion of a circuit, a portion of a processor, a portion of a program or software, etc. Of course, it may also be modular or non-modular. Furthermore, in the present embodiments, all components may be integrated into one processing unit, or each unit may physically exist separately, or two or more units may be integrated into one unit. The above integrated unit may be implemented in the form of hardware or in the form of software function modules.

If the integrated units are implemented in the form of a software function module and are not sold or used as independent products, they may be stored in a non-transitory computer-readable storage medium. Based on the understanding, the present embodiment provides a non-transitory computer-readable storage medium, which is applied to the decoder 180. The non-transitory computer-readable storage medium stores a computer program, when the computer program is executed by a second processor, the methods according to any one of the aforementioned embodiments are implemented.

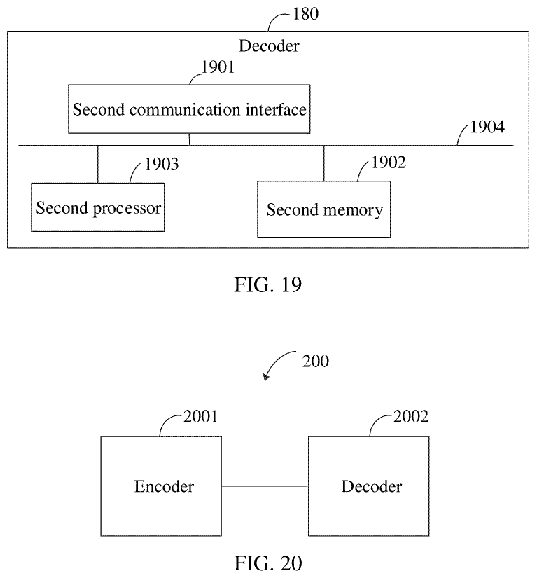

Based on the composition of the decoder 180 and the non-transitory computer-readable storage medium, referring to FIG. 19, a schematic diagram of a hardware structure of the decoder 180 provided by the embodiments of the present application is illustrated. As shown in FIG. 19, the decoder 180 may include: a second communication interface 1901, a second memory 1902, and a second processor 1903; and these components are coupled together via a second bus system 1904. It may be understood that the second bus system 1904 is used to achieve connection and communication among these components. The second bus system 1904 includes not only a data bus but also a power bus, a control bus and a status signal bus. However, for the sake of clarity, various buses are labeled as the second bus system 1904 in FIG. 19, where
the second communication interface 1901 is configured to receive and transmit signals during a process of transmitting and receiving information with other external network elements;
the second memory 1902 is configured to store a computer program that may is able to be run on the second processor 1903; and
the second processor 1903, is configured to perform following steps when running the computer program:
decoding a bitstream to determine prediction parameters of a current block; determining a first prediction block of the current block according to the prediction parameters; determining model parameters according to a first color component value and a second color component value of the first prediction block; determining a reference sample value of a first color component sample of the current block; determining a prediction value of a second color component sample of the current block according to the reference sample value of the first color component sample of the current block and the model parameters; and determining a reconstructed value of the second color component sample of the current block according to the prediction value of the second color component sample of the current block.

Optionally, as another embodiment, the second processor 1903 is further configured to perform any one of the methods described in the aforementioned embodiments when running the computer program.

It may be understood that the hardware functions of the second memory 1902 and the first memory 1702 are similar, and the hardware functions of the second processor 1903 and the first processor 1703 are similar, which will not be described in detail here.

The present embodiment provides a decoder, in the decoder, the model parameters determined according to the first color component value and the second color component value of the first prediction block sufficiently reflect the correlation between luma and chroma of the prediction block, and the correlation is applied to the existing luma information of the current block for chroma prediction, so that the accuracy of inter chroma prediction may be improved and bit rate may be saved, and coding efficiency may also be improved, thereby improving coding performance.

In yet another embodiment of the present application, referring to FIG. 20, a schematic diagram of a composition structure of a coding system provided by the embodiments of the present application is illustrated. As shown in FIG. 20, the coding system 200 may include an encoder 2001 and a decoder 2002.

In the embodiments of the present application, the encoder 2001 may be the encoder described in any one of the aforementioned embodiments, and the decoder 2002 may be the decoder described in any one of the aforementioned embodiments.

It should be noted that, in the present application, the terms “include”, “contain” or any other variations thereof are intended to cover non-exclusive inclusion, so that the process, method, article or apparatus including a series of elements includes not only those elements, but also other elements not explicitly listed, or further includes elements inherent to such process, method, article or apparatus. Without more constraints, an element defined by the phrase “include a . . . ” does not exclude the existence of other identical elements in the process, method, article or apparatus including the element.

The serial numbers of the embodiments of the present application are for description only and do not indicate the advantages or disadvantages of the embodiments.

The methods disclosed in several method embodiments provided by the present application may be arbitrarily combined without conflict, to obtain new method embodiments.

The features disclosed in several product embodiments provided by the present application may be arbitrarily combined without conflict to, obtain new product embodiments.

The features disclosed in several method embodiments or device embodiments provided by the present application may be arbitrarily combined without conflict, to obtain new method embodiments or device embodiments.

The above content is only implementations of the present application, but the protection scope of the present application is not limited thereto, and any skilled person in the art could readily conceive of changes or replacements within the technical scope disclosed of the present application, which shall be all included in the protection scope of the present application. Therefore, the protection scope of the present application shall be subject to the protection scope of claims.

### INDUSTRIAL APPLICABILITY

In the embodiments of the present application, whether at the encoding end or the decoding end, at which, after determining the prediction parameters of the current block, the first prediction block of the current block is determined according to the prediction parameters; the model parameters are determined according to the first color component value and the second color component value of the first prediction block; then the reference sample value of the first color component sample of the current block is determined, and the prediction value of the second color component sample of the current block is determined according to the reference sample value of the first color component sample of the current block and the model parameters. In this way, the encoding end may determine the prediction residual value of the second color component sample of the current block according to the prediction value of the second color component sample of the current block; and at the decoding end, the reconstructed value of the second color component sample of the current block may be determined according to the prediction value of the second color component sample of the current block. That is to say, the model parameters determined according to the first color component value and the second color component value of the first prediction block sufficiently reflect the correlation between luma and chroma of the prediction block, and the correlation is applied to the existing luma information of the current block for chroma prediction, so that the accuracy of inter chroma prediction may be improved and bit rate may be saved, and the coding efficiency may also be improved, thereby improving coding performance.

What is claimed is:

1. A decoding method, comprising:
decoding a bitstream to determine prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a reconstructed value of the second color component sample of the current block according to the prediction value of the second color component sample of the current block.

2. The method according to claim 1, wherein the prediction parameters comprise:
a motion vector, a reference picture index, and an inter prediction flag parameter, wherein the inter prediction flag parameter indicates a prediction mode used for decoding the current block, and the prediction mode comprises List0 prediction, List1 prediction, and bi-prediction;
wherein the method further comprises:
determining, a List0 prediction block of the current block, a List1 prediction block of the current block according to the prediction parameters;
wherein the first prediction block is the List0 prediction block of the current block; or
the first prediction block is the List1 prediction block of the current block; or
the first prediction blocks comprises the List0 prediction block of the current block and the List1 prediction block of the current block.

3. The method according to claim 2, wherein
the model parameters comprises coefficients of a target filter;
wherein the method further comprises:
determining the coefficients of the target filter according to the first color component value and the second color component value of the first prediction block.

4. The method according to claim 3, wherein
the coefficients of the target filter are coefficients used by the target filter in a case where a first error between an output value of the second color component value of the first prediction block processed by the target filter and an output value of the first color component value of the first prediction block processed by the target filter meets a first condition.

5. The method according to claim 4, wherein
the first condition is that the first error is minimum; or
the first condition is that the first error is within a first preset threshold range; or
the first condition is that a variation of the first error is within a second preset threshold range.

6. The method according to claim 3, wherein determining the coefficients of the target filter according to the first color component value and the second color component value of the first prediction block comprises:
determining autocorrelation parameters according to the first color component value of the first prediction block;
determining cross-correlation parameters according to the first color component value and the second color component value of the first prediction block; and
determining the coefficients of the target filter according to the autocorrelation parameters and the cross-correlation parameters.

7. The method according to claim 3, wherein the method further comprises:
the number of the coefficients of the target filter being equal to a first preset constant value; or
decoding the bitstream to determine the number of coefficients of the target filter; or
the target filter being a one-dimensional or two-dimensional filter with a preset shape; or
decoding the bitstream to determine a shape of the target filter.

8. The method according to claim 1, wherein determining the reference sample value of the first color component sample of the current block comprises:
determining the reference sample value of the first color component sample of the current block according to a reconstructed value of the first color component sample of the current block;
wherein the method further comprises:
determining the reconstructed value of the first color component sample of the current block according to the first color component value of the first prediction block;
wherein determining the reconstructed value of the first color component sample of the current block according to the first color component value of the first prediction block comprises:
determining the reconstructed value of the first color component sample of the current block according to a first color component value of a List0 prediction block of the current block and a first color component value of a List1 prediction block of the current block.

9. The method according to claim 1, wherein determining the reference sample value of the first color component sample of the current block comprises:
determining a prediction value of the first color component sample of the current block according to the first color component value of the first prediction block; and
determining the reference sample value of the first color component sample of the current block according to the prediction value of the first color component sample of the current block;
wherein determining the prediction value of the first color component sample of the current block according to the first color component value of the first prediction block comprises:
determining the prediction value of the first color component sample of the current block according to the first color component value of a List0 prediction block of the current block and the first color component value of a List1 prediction block of the current block.

10. The method according to claim 9, wherein the method further comprises:
determining a List0 weighting factor of the List0 prediction block of the current block and a List1 weighting factor of the List1 prediction block of the current block;
determining, according to the List0 weighting factor and the List weighting factor, a weighted sum of the first color component value of the List0 prediction block of the current block and the first color component value of the List1 prediction block of the current block; and
determining the prediction value of the first color component sample of the current block according to the weighted sum.

11. The method according to claim 3, wherein determining the prediction value of the second color component sample of the current block according to the reference sample value of the first color component sample of the current block and the model parameters comprises:
determining a first input value of the target filter based on the reference sample value of the first color component sample of the current block;
determining a first output value of the target filter based on the first input value and the model parameters; and
determining the prediction value of the second color component sample of the current block based on the first output value.

12. The method according to claim 11, wherein determining the first input value of the target filter according to the reference sample value of the first color component sample of the current block comprises:
performing a first filtering process on the reference sample value of the first color component sample of the current block, to determine the first input value;
wherein the method further comprises:
the first filtering process comprising at least one of: low-pass filtering, or down-sampling filtering; or
setting, by the first filtering process, the first input value to be equal to the reference sample value of the first color component sample of the current block.

13. The method according to claim 11, wherein determining the prediction value of the second color component sample of the current block based on the first output value comprises:
performing a second filtering process on the first output value, to determine a second output value; and
determining the prediction value of the second color component sample of the current block based on the second output value;
wherein the method further comprises:
the second filtering process comprising at least one of: low-pass filtering, or up-sampling filtering; or
setting, by the second filtering process, the second output value to be equal to the first output value; or
the first output value comprising a prediction value of a portion of the second color component sample of the current block;
wherein determining the prediction value of the second color component sample of the current block based on the second output value comprises:
performing a first process on the second output value, to obtain the prediction value of the second color component sample of the current block, wherein the first process is a clip operation that restricts the second output value within a preset value range.

14. The method according to claim 1, wherein the method further comprises:
determining a prediction residual value of the first color component sample of the current block; and
determining the reference sample value of the first color component sample of the current block according to the prediction residual value of the first color component sample of the current block.

15. The method according to claim 14, wherein the method further comprises:
determining a first color component residual value and a second color component residual value of the first prediction block; and
determining the model parameters according to the first color component residual value and the second color component residual value of the first prediction block;
correspondingly, determining the prediction value of the second color component sample of the current block according to the reference sample value of the first color component sample of the current block and the model parameters comprises:
determining an initial prediction residual value of the second color component sample of the current block according to the prediction residual value of the first color component sample of the current block and the model parameters;
determining, according to the first prediction block, an initial prediction value of the second color component sample of the current block; and
determining the prediction value of the second color component sample of the current block according to the initial prediction residual value and the initial prediction value of the second color component sample of the current block.

16. The method according to claim 1, wherein determining the reconstructed value of the second color component sample of the current block according to the prediction value of the second color component sample of the current block comprises:
decoding the bitstream to determine a prediction residual value of the second color component sample of the current block; and
determining the reconstructed value of the second color component sample of the current block according to the prediction value of the second color component sample of the current block and the prediction residual value of the second color component sample of the current block.

17. An encoding method, comprising:
determining prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a prediction residual value of the second color component sample of the current block according to the prediction value of the second color component sample of the current block.

18. A decoder, comprising a second memory and a second processor; wherein
the second memory is configured to store a computer program that is able to be run on the second processor; and
the second processor, is configured to perform:
decoding a bitstream to determine prediction parameters of a current block;
determining a first prediction block of the current block according to the prediction parameters;
determining model parameters according to a first color component value and a second color component value of the first prediction block;
determining a reference sample value of a first color component sample of the current block;
determining a prediction value of a second color component sample of the current block according to the reference sample value of the first color component sample of the current block and the model parameters; and
determining a reconstructed value of the second color component sample of the current block according to the prediction value of the second color component sample of the current block.

19. The decoder according to claim 18, wherein the prediction parameters comprise:
a motion vector, a reference picture index, and an inter prediction flag parameter, wherein the inter prediction flag parameter indicates a prediction mode used for decoding the current block, and the prediction mode comprises List0 prediction, List1 prediction, and bi-prediction;
wherein the second processor is further configured to perform:
determining, a List prediction block of the current block, a List1 prediction block of the current block according to the prediction parameters;
wherein the first prediction block is the List0 prediction block of the current block; or
the first prediction block is the List1 prediction block of the current block; or
the first prediction blocks comprises the List0 prediction block of the current block and the List1 prediction block of the current block.

20. The decoder according to claim 19, wherein the model parameters coefficients of a target filter;
wherein the second processor is further configured to perform:
determining the coefficients of the target filter according to the first color component value and the second color component value of the first prediction block.
